(19) United States
(12) Patent Application Publication
(10) Pub. No.: US 2025/0166594 A1
(43) Pub. Date: May 22, 2025

(54) SOUND ABSORPTION APPARATUS AND PARAMETER ESTIMATION METHOD

(71) Applicant: KABUSHIKI KAISHA TOSHIBA, Tokyo (JP)

(72) Inventor: Tatsuhiko GOTO, Kawasaki Kanagawa (JP)

(73) Assignee: KABUSHIKI KAISHA TOSHIBA, Tokyo (JP)

(21) Appl. No.: 18/773,982

(22) Filed: Jul. 16, 2024

(30) Foreign Application Priority Data
Nov. 21, 2023 (JP) 2023-197641

(51) Int. Cl. G10K 11/16

(52) U.S. Cl. CPC G10K 11/16

(57) ABSTRACT

According to an embodiment, a sound absorption apparatus includes a hollow member, a first plate, a second plate, a third plate, and a connection member. The first plate is connected to the hollow member and is configured to vibrate. The second plate is provided opposite to the first plate and is connected to the hollow member. The third plate is disposed between the first plate and the second plate and is configured to vibrate. The connection member connects the third plate to the first plate. The first plate, the second plate, and the hollow member form an internal space. The third plate is suspended from the first plate by the connection member in the internal space.

### CROSS-REFERENCE TO RELATED APPLICATION

This application is based upon and claims the benefit of priority from Japanese Patent Application No. 2023-197641, filed Nov. 21, 2023, the entire contents of which are incorporated herein by reference.

### FIELD

Embodiments described herein relate generally to a sound absorption apparatus and a parameter estimation method.

### BACKGROUND

An acoustic metamaterial having a configuration in which Helmholtz resonance and plate vibration are coupled has been known. The coupling of the Helmholtz resonance and the plate vibration enables a wide band of sound absorption characteristics. However, the production of a perforated plate, which is also called a Helmholtz sound hole plate, requires a high cost.

Meanwhile, it is a social need to be able to reduce noise of two frequencies in a frequency band of 200 Hz or less. As the noise having two frequencies, for example, a noise having a fundamental frequency and a noise having a frequency twice the fundamental frequency are assumed. For example, in a case where the noise is derived from a power source, the fundamental frequency may be 50 Hz or 60 Hz.

### BRIEF DESCRIPTION OF THE DRAWINGS

FIG. 1 is a cross-sectional view illustrating a sound absorption apparatus according to an embodiment.

FIG. 2 is a diagram illustrating a vibration model corresponding to the sound absorption apparatus of FIG. 1.

FIG. 3 is a side view illustrating an example of a connection member illustrated in FIG. 1.

FIG. 4 is a perspective view illustrating a state in which a weight is attached to a suspended plate illustrated in FIG. 3.

FIG. 5 is a diagram for describing an assembling method according to the embodiment.

FIG. 6 is a diagram for describing the assembling method according to the embodiment.

FIG. 7 is a diagram for describing the assembling method according to the embodiment.

FIG. 8 is a diagram for describing the assembling method according to the embodiment.

FIG. 9 is a diagram for describing the assembling method according to the embodiment.

FIG. 10 is a diagram for describing the assembling method according to the embodiment.

FIG. 11 is a diagram for describing the assembling method according to the embodiment.

FIG. 12 is a diagram for describing the assembling method according to the embodiment.

FIG. 13 is a diagram illustrating sound absorption characteristics of the sound absorption apparatus according to a first example.

FIG. 14 is a diagram illustrating the sound absorption characteristics of the sound absorption apparatus according to a first example.

FIG. 15 is a diagram illustrating sound absorption characteristics of a sound absorption apparatus according to a second example.

FIG. 16 is a diagram illustrating the sound absorption characteristics of the sound absorption apparatus according to the second example.

FIG. 17 is a diagram illustrating sound absorption characteristics of a sound absorption apparatus according to a third example.

FIG. 18 is a diagram illustrating the sound absorption characteristics of the sound absorption apparatus according to the third example.

FIG. 19 is a diagram illustrating the sound absorption characteristics of the sound absorption apparatus according to the third example.

FIG. 20 is a diagram illustrating sound absorption characteristics of a sound absorption apparatus according to a fourth example.

FIG. 21 is a diagram for describing a parameter estimation method according to the embodiment.

FIG. 22 is a diagram for describing a first parameter estimation method according to the embodiment.

FIG. 23 is a diagram for describing the first parameter estimation method according to the embodiment.

FIG. 24 is a diagram for describing the first parameter estimation method according to the embodiment.

FIG. 25 is a diagram for describing the first parameter estimation method according to the embodiment.

FIG. 26 is a diagram for describing the first parameter estimation method according to the embodiment.

FIG. 27 is a diagram for describing the first parameter estimation method according to the embodiment.

FIG. 28 is a diagram for describing the first parameter estimation method according to the embodiment.

FIG. 29 is a diagram for describing a second parameter estimation method according to the embodiment.

FIG. 30 is a diagram for describing the second parameter estimation method according to the embodiment.

FIG. 31 is a diagram for describing the second parameter estimation method according to the embodiment.

FIG. 32 is a diagram for describing the second parameter estimation method according to the embodiment.

FIG. 33 is a diagram for describing a third parameter estimation method according to the embodiment.

FIG. 34 is a diagram for describing the third parameter estimation method according to the embodiment.

FIG. 35 is a diagram for describing the third parameter estimation method according to the embodiment.

FIG. 36 is a diagram for describing an example of parameter tuning according to the embodiment.

FIG. 37 is a diagram for describing an example of parameter tuning according to the embodiment.

FIG. 38 is a diagram illustrating a configuration in which a piezoelectric element is provided on a front plate according to the embodiment.

FIG. 39 is a diagram illustrating a configuration in which the piezoelectric element is provided on the suspended plate according to the embodiment.

FIG. 40 is a diagram illustrating an acoustic metamaterial according to the embodiment.

### DETAILED DESCRIPTION

According to an embodiment, a sound absorption apparatus includes a hollow member, a first plate, a second plate, a third plate, and a connection member. The first plate is connected to the hollow member and is configured to vibrate. The second plate is provided opposite to the first plate and is connected to the hollow member. The third plate is disposed between the first plate and the second plate and is configured to vibrate. The connection member connects the third plate to the first plate. The first plate, the second plate, and the hollow member form an internal space. The third plate is suspended from the first plate by the connection member in the internal space.

According to an embodiment, there is provided a sound absorption apparatus having a simple configuration capable of absorbing noise of two frequencies in a low frequency band.

Hereinafter, embodiments will be described with reference to the accompanying drawings.

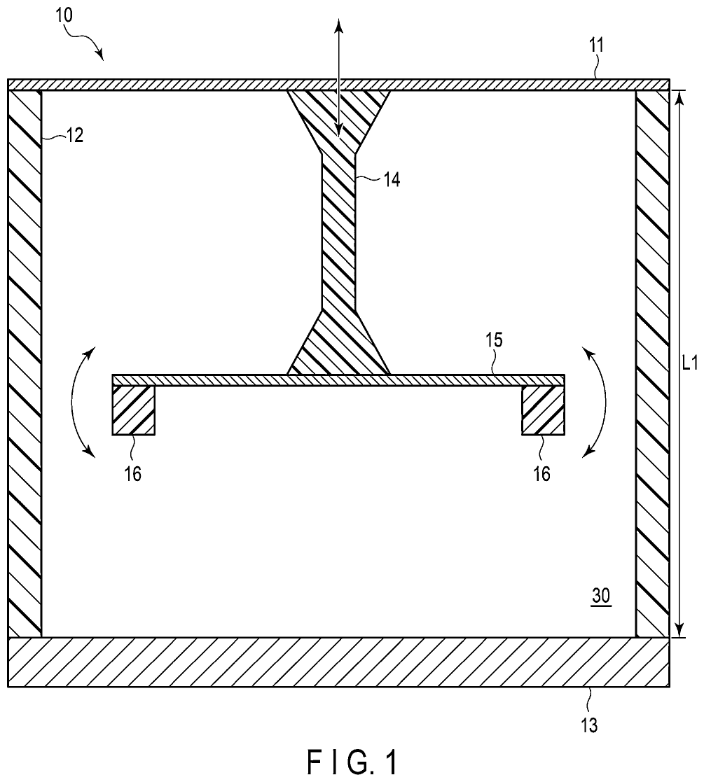

FIG. 1 schematically illustrates a cross section of a sound absorption apparatus 10 according to an embodiment. As illustrated in FIG. 1, the sound absorption apparatus 10 includes a front plate 11, a hollow member 12, a back plate 13, a connection member 14, a suspended plate 15, and a plurality of weights 16.

The hollow member 12 is, for example, a cylindrical frame. The hollow member 12 has a first opening and a second opening facing the first opening. The front plate 11 is, for example, a flat plate. The front plate 11 has, for example, a circular shape. The front plate 11 is connected to the hollow member 12 so as to close the first opening of the hollow member 12. An outer edge portion of the front plate 11 is supported by the hollow member 12 so that the front plate 11 can vibrate in an axial direction as indicated by a double-headed arrow. The axial direction is a direction along a virtual axis of the sound absorption apparatus 10 and is a direction perpendicular to the front plate 11. The back plate 13 is, for example, a flat plate. The back plate 13 has, for example, a circular shape. The back plate 13 is connected to the hollow member 12 so as to close the second opening of the hollow member 12. The back plate 13 is provided opposite to the front plate 11 at a distance of a length L1 of the hollow member 12. The length L1 of the hollow member 12 is a dimension along an axis of the sound absorption apparatus 10. The hollow member 12, the front plate 11, and the back plate 13 form an internal space 30. The length L1 of the hollow member 12 corresponds to a thickness of the internal space 30.

The front plate 11, the back plate 13, and the hollow member 12 may be connected using an adhesive, a fixture, or the like, but are not limited thereto. In an example described later, the front plate 11 and the back plate 13 are pressed against the hollow member 12 using a tension of a string member, whereby the front plate 11 and the back plate 13 are connected to the hollow member 12.

The connection member 14 and the suspended plate 15 are disposed between the front plate 11 and the back plate 13 in the internal space 30. The connection member 14 connects the suspended plate 15 to the front plate 11. Specifically, the suspended plate 15 is suspended from the front plate 11 by the connection member 14 in the internal space 30. One end of the connection member 14 is connected to a central portion of the front plate 11, and the other end of the connection member 14 is connected to a central portion of the suspended plate 15. The suspended plate 15 is, for example, a circular flat plate. The central portion of the suspended plate 15 is supported by the connection member 14 so that the suspended plate 15 can vibrate in the axial direction as indicated by the double-headed arrow. The weights 16 are dispersedly disposed on an outer edge portion of the suspended plate 15.

Instead of the weights 16, a weight having a shape matching the outer edge portion of suspended plate 15, that is, an annular weight may be used. The annular weight is disposed on the outer edge portion of the suspended plate 15. In a case where a plurality of annular weights is used, the annular weights may be stacked. The weights 16 may be positioned either between the outer edge portion of the suspended plate 15 and the front plate 11, between the outer edge portion of the suspended plate 15 and the back plate 13, or between the outer edge portion of suspended plate 15 and the hollow member 12.

The sound absorption apparatus 10 having the above-described configuration can absorb or reduce noise of two frequencies in a low frequency band of 200 Hz or less. In one example, the sound absorption apparatus 10 is designed so as to be able to absorb or reduce noise of a fundamental frequency and second harmonics thereof (specifically, noise having a frequency twice the fundamental frequency) generated by a noise source such as an electronic device. If the noise comes from a power source, the fundamental frequency may be 50 Hz or 60 Hz. In a case where the noise is derived from a device having a fan, the fundamental frequency is obtained by multiplying a rotation frequency of the fan by the number of blades of the fan. For example, in the case where a rotational speed is 600 rpm and the fan has five blades, the fundamental frequency is 50 Hz. In addition, since the Helmholtz sound hole plate is unnecessary and the number of components is small, the manufacturing cost is low and the assembly is easy.

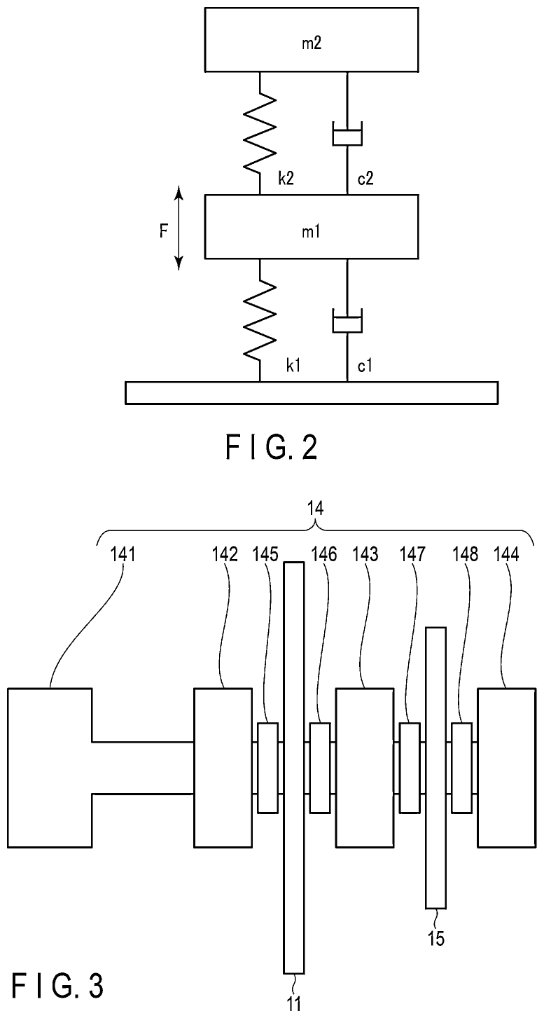

The vibration system having the structure illustrated in FIG. 1 can be represented by a two-degree-of-freedom system model illustrated in FIG. 2. In FIG. 2, m₁, k₁, and c₁ are a mass, a spring constant, and an attenuation coefficient of a first degree-of-freedom system, and m₂, k₂, and c₂ are a mass, a spring constant, and an attenuation coefficient of a second degree-of-freedom system. The mass m₁ represents a mass of the connection member 14 and an equivalent mass of the front plate 11. A spring constant k₁ represents an equivalent rigidity of the front plate 11 and an air spring of the internal space 30. The attenuation coefficient c₁ represents an equivalent viscosity of the front plate 11. The mass m₂ represents a mass of the weights 16 and an equivalent mass of the suspended plate 15. A spring constant k₂ represents an equivalent rigidity of the suspended plate 15. The damping coefficient c₂ represents an equivalent viscosity of the suspended plate 15.

In the sound absorption apparatus 10, the front plate 11 receives a sound wave to vibrate, and the suspended plate 15 vibrates with the vibration of the front plate 11. As the vibration mode, an in-phase drive mode in which the front plate 11 and the suspended plate 15 vibrate in the same direction and a reversed-phase drive mode in which the front plate 11 and the suspended plate 15 vibrate in opposite directions are generated. As a result, the frequency having a peak value of a vibration speed is separated into two frequencies. Since the sound absorption effect is correlated with a kinetic energy, two frequencies that take the peak values of the sound absorption coefficient are resultantly generated.

The sound absorption frequency, which is a frequency to be reduced by the sound absorption apparatus 10, can be adjusted by, for example, the following five parameters.

### (1) Length L1 of Hollow Member 12

The air spring of the internal space 30 depends on the length L1 of the hollow member 12. Specifically, the smaller the length L1, the stronger the air spring in the internal space 30. Therefore, the spring constant k₁ can be adjusted by changing the length L1. When the length L1 is increased, the spring constant k₁ decreases, thereby decreasing the frequency at which a sound absorption coefficient peak value is obtained. When the length L1 is reduced, the spring constant k₁ increases, thereby increasing the frequency at which the sound absorption coefficient peak value is obtained.

### (2) Radius of Suspended Plate 15

The rigidity of the suspended plate 15 depends on the radius of the suspended plate 15. Specifically, the smaller the radius of the suspended plate 15, the higher the rigidity of the suspended plate 15. Therefore, the spring constant k₂ can be adjusted by changing the radius of the suspended plate 15. When the radius is enlarged, the spring constant k₂ decreases, thereby reducing an interval between frequencies taking the sound absorption coefficient peak value. When the radius is reduced, the spring constant k₂ increases, thereby increasing the interval between frequencies taking the sound absorption coefficient peak value.

### (3) Number of Weights 16

The mass m₂ can be adjusted by changing the number of weights 16. Specifically, the larger the number of weights 16, the larger the mass m₂. When the mass m₂ is increased, a mass ratio (m₂/m₁) of the two-degree-of-freedom system increases, thereby decreasing the frequency at which the sound absorption coefficient peak value is obtained. When the mass m₂ is decreased, the mass ratio (m₂/m₁) is decreased, thereby increasing the frequency at which the sound absorption coefficient peak value is obtained.

The change in the number of weights 16 causes a change in the spring constant k₂. Specifically, when the number of weights 16 is increased, the spring constant k₂ decreases, and when the number of weights 16 is decreased, the spring constant k₂ increases. The weight of weight 16 may be changed without changing the number of weights 16. In this case, a change in the spring constant k₂ can be suppressed.

### (4) Thickness of Suspended Plate 15

The rigidity of the suspended plate 15 depends on the thickness of the suspended plate 15. Specifically, the thicker the suspended plate 15, the higher the rigidity of the suspended plate 15. Therefore, the spring constant k₂ can be adjusted by changing the thickness of the suspended plate 15. When the thickness of the suspended plate 15 is reduced, the spring constant k₂ decreases, thereby reducing an interval between frequencies having the sound absorption coefficient peak value. Increasing the thickness of the suspended plate 15 increases the spring constant k₂, thereby increasing the interval between frequencies taking the sound absorption coefficient peak value.

### (5) Mass of Connection Member 14

The mass m₁ can be adjusted by changing the mass of the connection member 14. The modification of the mass m₁ results in a modification of the eigenfrequency (natural frequency) in the absence of the suspended plate 15. Therefore, the center frequency can be adjusted by changing the mass of the connection member 14.

Hereinafter, the frequency at which the sound absorption coefficient peak value is obtained is also referred to as a peak frequency.

With adjustment of these parameters, for example, the sound absorption apparatus 10 can be adjusted so that sound absorbing effects of 60 Hz and 120 Hz can be obtained.

When the eigenfrequency of the degree-of-freedom system (m₁, k₁) and the eigenfrequency of the degree-of-freedom system (m₂, k₂) are brought close to each other, eigenvalue matching occurs, and the values of the two sound absorption coefficient peaks are close to each other. It is desirable that the two sound absorption coefficient peak values are close to each other, but the two sound absorption coefficient peak values may be apart from each other as long as the two sound absorption coefficient peak values are a predetermined value (for example, 0.6) or more.

A specific example of the sound absorption apparatus 10 and an assembly procedure example of the sound absorption apparatus 10 according to the specific example will be described.

FIG. 3 schematically illustrates an example of the connection member 14. As shown in FIG. 3, the connection member 14 includes a plastic bolt 141, plastic nuts 142, 143, 144, and plastic washers 145, 146, 147, 148. In the example illustrated in FIG. 3, the bolt 141 is a half bolt. An opening for inserting the plastic bolt 141 is provided in a central portion of the front plate 11 and the suspended plate 15. The plastic nut 142 is screwed onto the plastic bolt 141, the plastic bolt 141 is inserted into the plastic washer 145, the front plate 11, and the plastic washer 146, the plastic nut 143 is screwed onto the plastic bolt 141, the plastic bolt 141 is inserted into the plastic washer 147, the suspended plate 15, and the plastic washer 148, and the plastic nut 144 is screwed onto the plastic bolt 141. The front plate 11 is fixed to the plastic bolt 141 by being clamped by the plastic nuts 142 and 143, and the suspended plate 15 is fixed to the plastic bolt 141 by being clamped by the plastic nuts 143 and 144. An additional washer such as a stainless washer may be provided between the plastic bolt and the plastic washer. The addition of the washer includes continuously providing a plurality of washers at least between any two of the plastic nut 142, the front plate 11, the plastic nut 143, the suspended plate 15, and the plastic nut 144 inserted through the plastic bolt 141 in the described order, and/or providing one or more washers between a head of the plastic bolt 141 and the plastic nut 142. The washer is not limited to be made of plastic or stainless steel, and a plurality of types having different materials can be mixed and used. The weight of the connection member 14 can be adjusted by adding a washer. The washer through which the bolt is inserted is sandwiched by the nuts. The plastic nut 143 may be divided into two parts of a nut that clamps the front plate 11 and a nut that clamps the suspended plate 15.

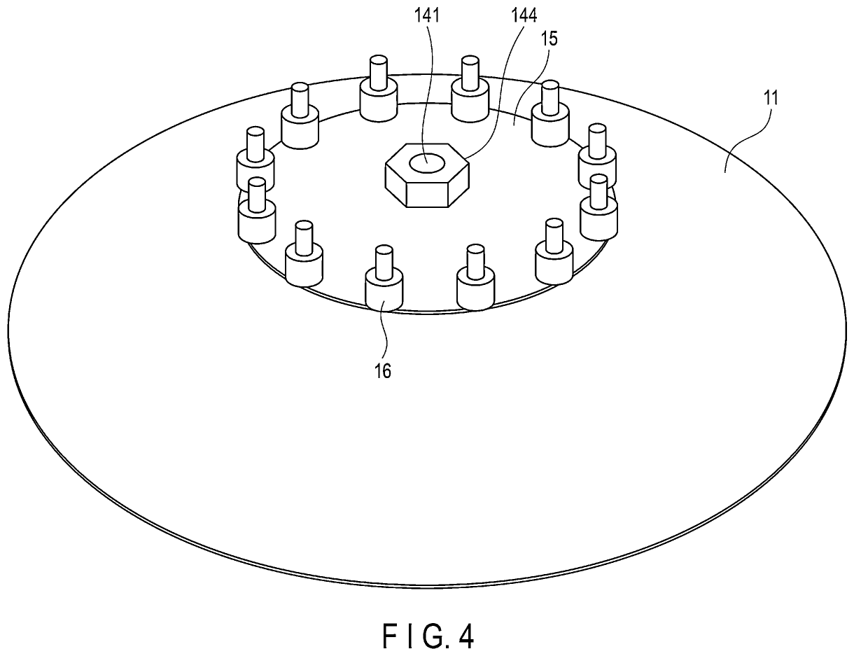

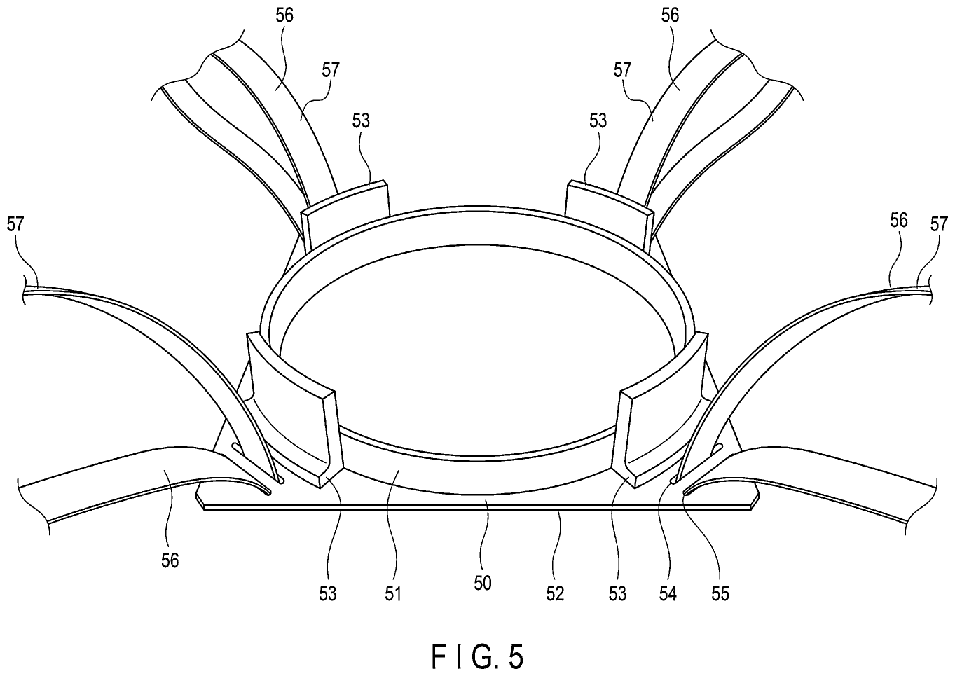

FIG. 4 illustrates a state in which twelve weights 16 are attached to the suspended plate 15 at twelve equal intervals. In the example shown in FIG. 4, each weight 16 includes a plastic screw, a plastic collar, and a plastic nut. An opening for inserting a plastic screw is provided in the outer edge portion of the suspended plate 15. The plurality of openings is provided, for example, at positions that are rotationally symmetric with respect to the center of the suspended plate 15 a plurality of times. The weights 16 are fixed to the suspended plate 15 by fastening of the plastic screw and the plastic nut. For example, the plurality of weights 16 is disposed such that the center of gravity overlaps the center of the suspended plate 15. Attachment of the weights 16 to the suspended plate 15 may be performed prior to attachment of the suspended plate 15 to the connection member 14, or may be performed subsequent to the attachment of the suspended plate 15 to the connection member 14.

FIG. 5 illustrates a fixation member 50 and bands 56, which correspond to a fixture. As illustrated in FIG. 5, the fixation member 50 includes a cylindrical member 51, a fixation plate 52, and guides 53. The cylindrical member 51 and the guides 53 are fixed to the fixation plate 52. A portion of the fixation plate 52 facing the front plate 11 is opened. Furthermore, two slits 54 and 55 for passing the band 56 are provided at each of four corners of the fixation plate 52. Each band 56 is passed through its corresponding two slits 54 and 55. A hook-and-loop fastener 57 is provided on one surface of the band 56.

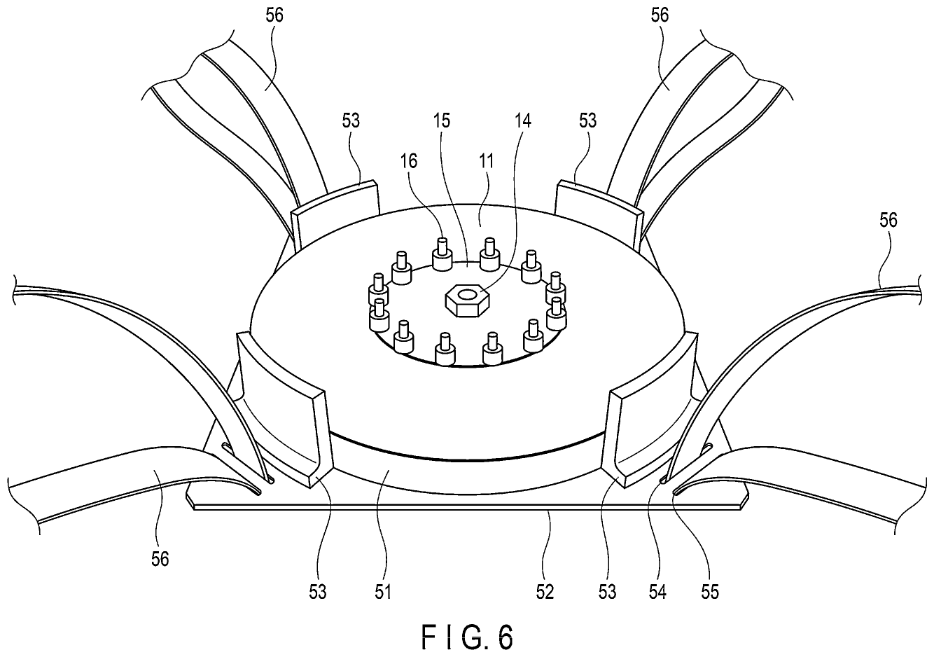

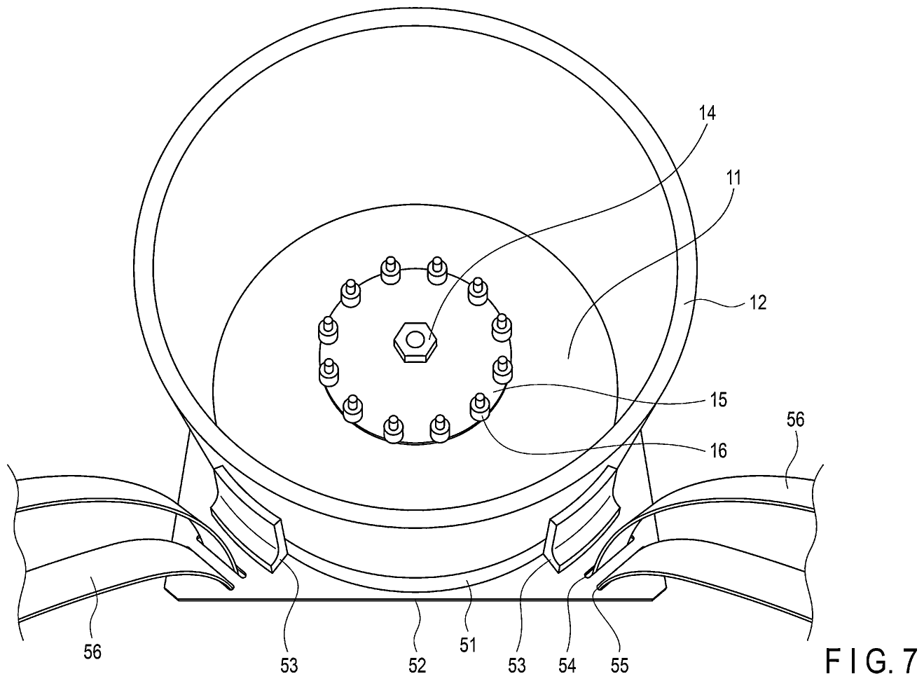

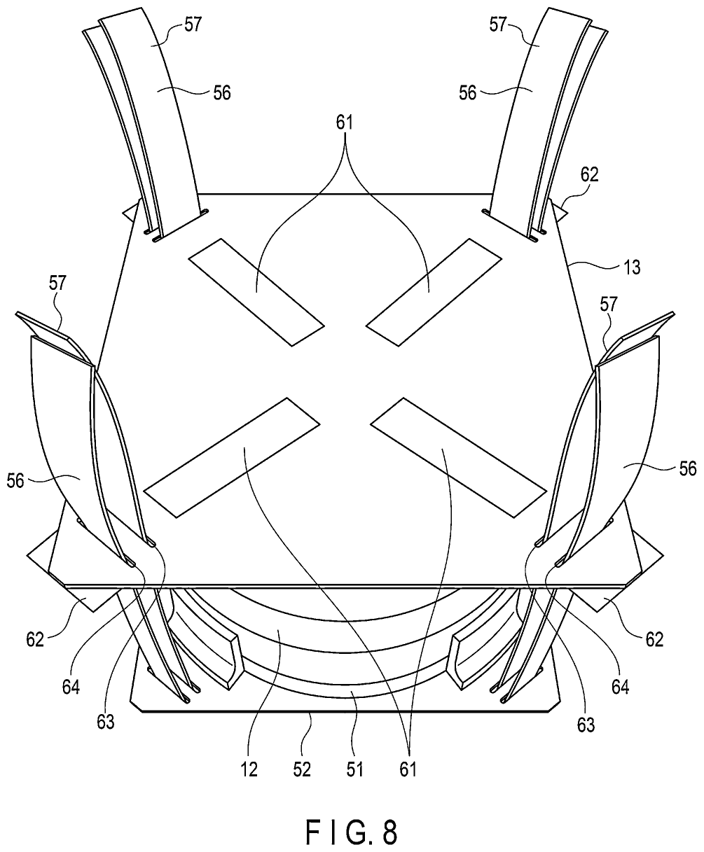

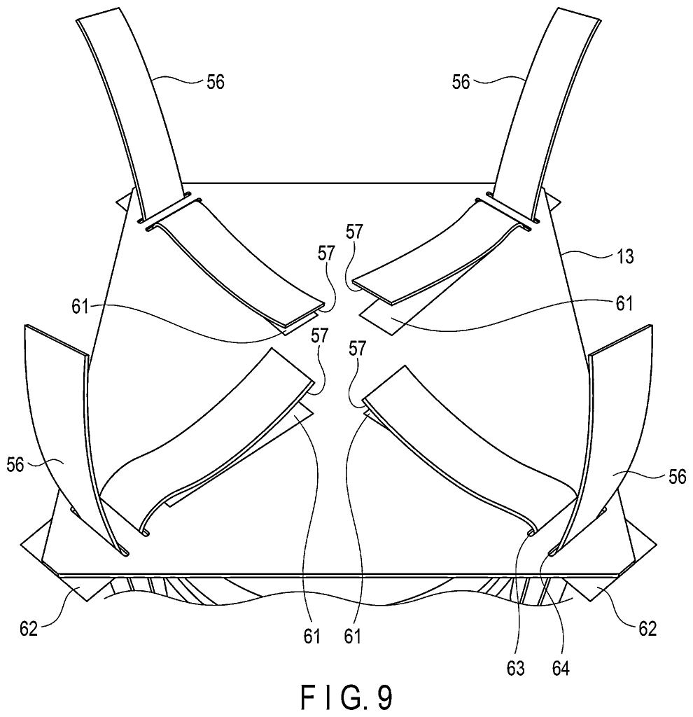

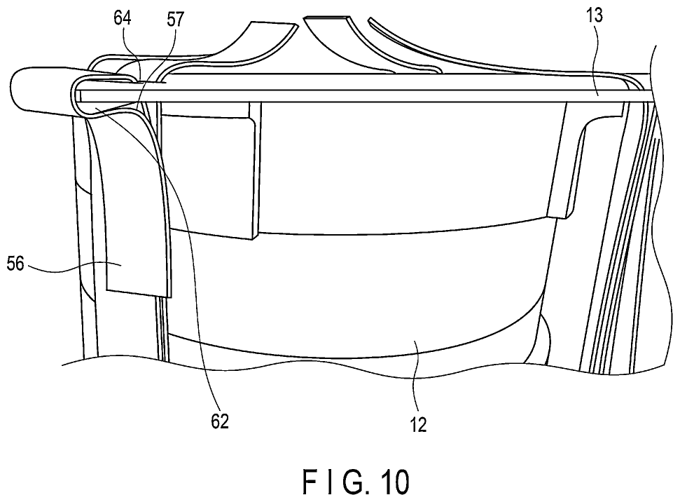

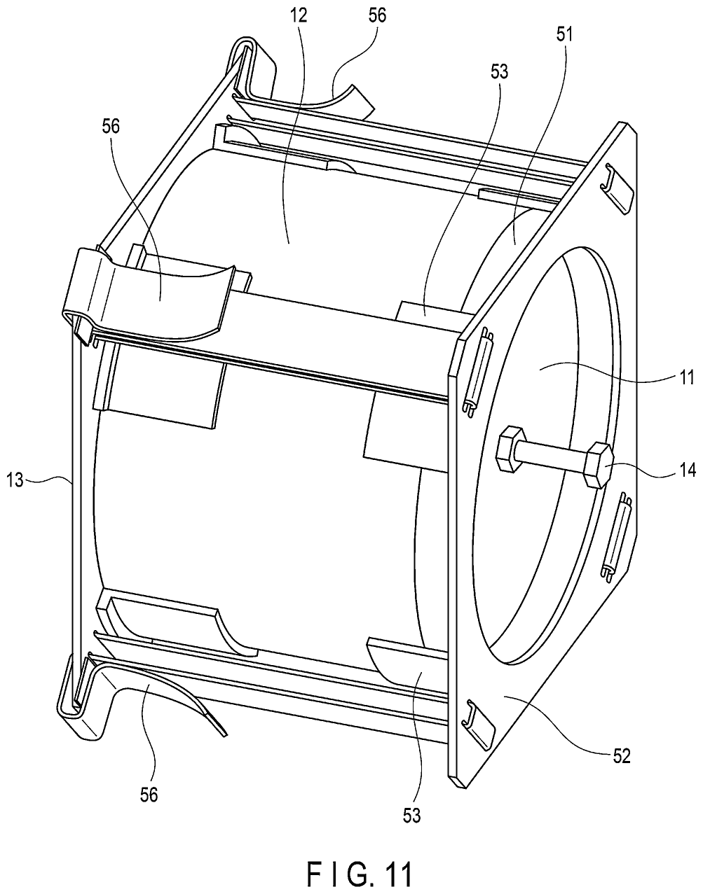

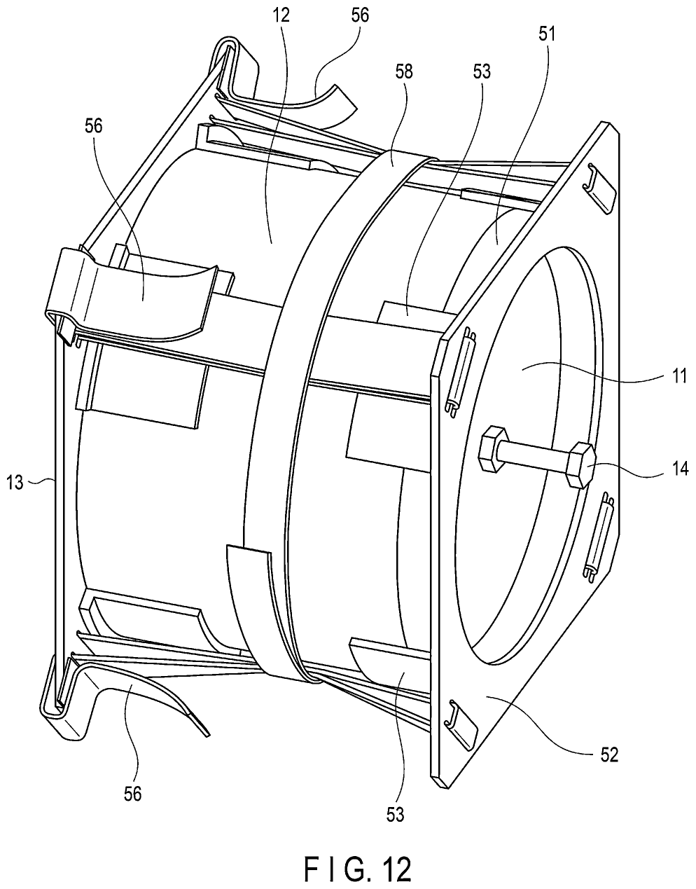

As illustrated in FIG. 6, the front plate 11 to which the connection member 14 and the suspended plate 15 are attached is placed on the fixation member 50. The front plate 11 is positioned by the guides 53. Then, as illustrated in FIG. 7, the hollow member 12 is placed on the front plate 11. The hollow member 12 is positioned by the guides 53. The outer edge portion of the front plate 11 is sandwiched between the cylindrical member 51 and the hollow member 12 of the fixation member 50. Subsequently, as illustrated in FIG. 8, the back plate 13 is placed on the hollow member 12. In this example, the back plate 13 is a square flat plate and also functions as a part of the fixture. The back plate 13 is provided with guides for positioning the back plate 13 with respect to the hollow member 12. In addition, two slits 63 and 64 for passing the band 56 are provided at each of four corners of the back plate 13. A surface of the back plate 13 facing the front plate 11 is referred to as a front surface. Hook-and-loop fasteners 62 are provided at four corners of the front surface of the back plate 13, and hook-and-loop fasteners 61 are provided on the back surface of the back plate 13. The hook-and-loop fasteners 62 are located on the outer edge side of the back plate 13 with respect to the slit 64. The hook-and-loop fasteners 61 are located closer to the center of back plate 13 than the slit 63. As illustrated in FIG. 9, the hook-and-loop fastener 57 of the band 56 is pressed against the hook-and-loop fastener 61 of the back plate 13 with one end of each band 56 passing through one slit 63 of the back plate 13, whereby one end of the band 56 is fixed to the back plate 13. Further, as shown in FIG. 10, the other end of the band 56 is passed through the other slit 64 of the back plate 13, and the hook-and-loop fastener 57 of the band 56 is pressed against the hook-and-loop fastener 62 of the back plate 13 while pulling the band 56, whereby the other end of the band 56 is also fixed to the back plate 13. The tension of the band 56 generates an axial force (specifically, a force acting so that the back plate 13 and the fixation member 50 approach each other), whereby the front plate 11 and the back plate 13 are fixed to the hollow member 12 as illustrated in FIG. 11. In order to increase the axial force, the band 58 may be wound in the circumferential direction, as shown in FIG. 12.

In a case where the fixture described with reference to FIGS. 5 to 12 is used, the sound absorption apparatus 10 can be easily disassembled. This facilitates parameter adjustment.

Next, a change in the sound absorption characteristics of the sound absorption apparatus 10 by parameter adjustment will be described. Here, a result of measuring the normal incidence sound absorption coefficient is illustrated as the sound absorption characteristics.

As a matter common to the examples, the hollow member 12 has an outer diameter of 196 mm and an inner diameter of 190 mm. The front plate 11 is an aluminum plate having a diameter of 196 mm and a thickness of 0.5 mm. The connection member 14 includes an M10 plastic bolt, three M10 plastic nuts, and four plastic washers, similar to that shown in FIG. 3. The weight 16 includes an M3 plastic bolt, a plastic collar, and a plastic nut, and has a weight of 0.5 g. A polyvinyl chloride (PVC) tape is attached to both surfaces of the suspended plate 15 in order to prevent flutter.

In a first example, the suspended plate 15 is an aluminum plate having a diameter of 115 mm and a thickness of 0.3 mm. The four weights 16 are attached to the outer edge portion of the suspended plate 15 in four equal intervals.

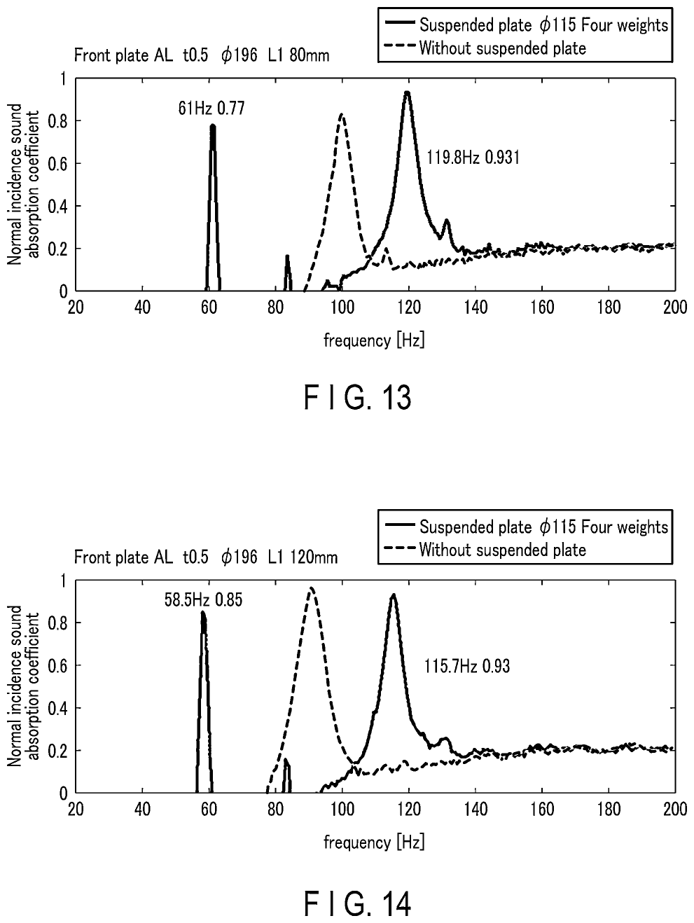

FIG. 13 illustrates sound absorption characteristics of the sound absorption apparatus 10 according to the first example under a condition that the length L1 is 80 mm. In FIG. 13, a solid line indicates the sound absorption characteristics of the sound absorption apparatus 10 according to the first example, and a broken line indicates the sound absorption characteristics of a sound absorption apparatus according to a comparative example. The sound absorption apparatus according to the comparative example is obtained by removing the suspended plate 15 from the sound absorption apparatus 10 according to the first example. From FIG. 13, it can be confirmed that the sound absorption apparatus according to the comparative example takes a sound absorption coefficient peak value at 100 Hz, and the sound absorption apparatus 10 according to the first example takes two sound absorption coefficient peak values in the vicinity of 60 Hz and 120 Hz. The peak near 60 Hz is sound absorbing performance generated in a mode in which the front plate 11 and the suspended plate 15 vibrate in the same phase, and the peak near 120 Hz is sound absorbing performance generated in a mode in which the front plate 11 and the suspended plate 15 vibrate in opposite phases.

Therefore, it can be confirmed that the sound absorption apparatus 10 having the configuration illustrated in FIG. 1 exhibits high sound absorbing performance at two frequencies.

FIG. 14 illustrates sound absorption characteristics of the sound absorption apparatus 10 according to the first example under a condition that the length L1 is 120 mm. Comparing FIG. 13 with FIG. 14, it can be confirmed that the peak frequency decreases as the length L1 increases.

In a second example, a suspended plate 15 is an aluminum plate having a diameter of 95 mm and a thickness of 0.3 mm. The four weights 16 are attached to the outer edge portion of the suspended plate 15 in four equal intervals.

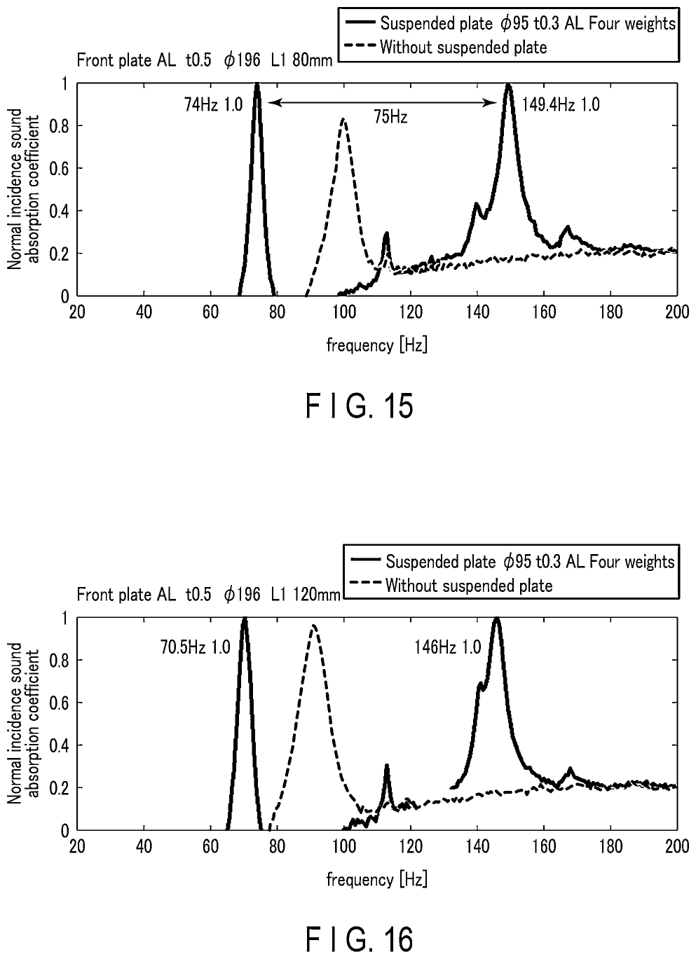

FIG. 15 illustrates sound absorption characteristics of a sound absorption apparatus 10 according to the second example under the condition that a length L1 is 80 mm. Comparing FIG. 13 with FIG. 15, it can be confirmed that an interval between peak frequencies increases when a radius of the suspended plate 15 is reduced (that is, the rigidity of the suspended plate 15 is increased).

FIG. 16 illustrates sound absorption characteristics of the sound absorption apparatus 10 according to the second example under the condition that the length L1 is 120 mm. Comparing FIG. 15 with FIG. 16, it can be confirmed that the peak frequency decreases as the length L1 increases.

In a third example, a suspended plate 15 is an aluminum plate having a diameter of 95 mm and a thickness of 0.3 mm. Twelve weights 16 are attached to an outer edge portion of a suspended plate 15 in twelve equal intervals.

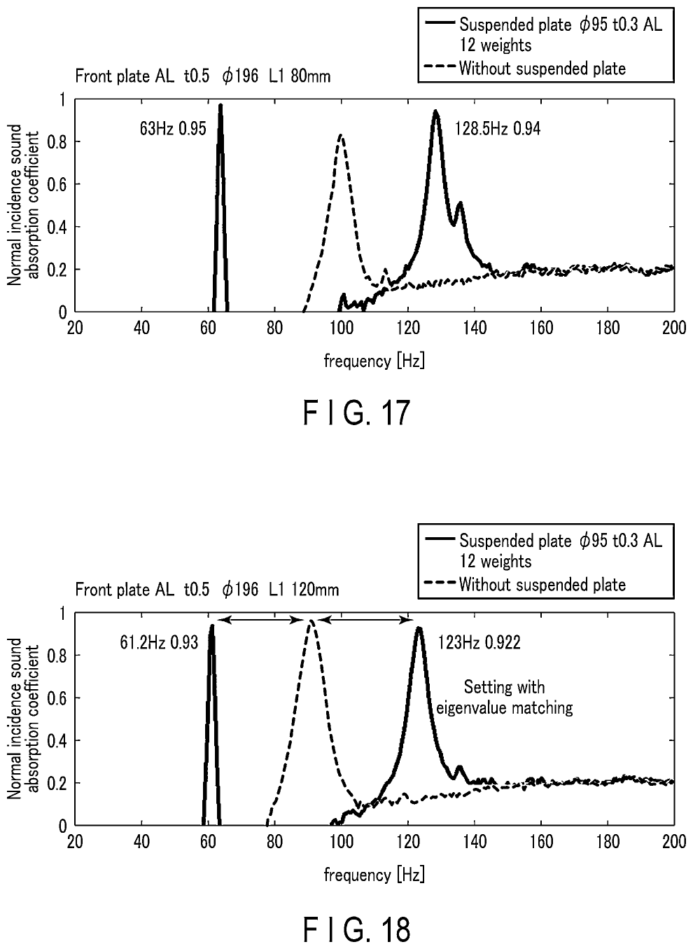

FIG. 17 illustrates sound absorption characteristics of the sound absorption apparatus 10 according to the third example under a condition that a length L1 is 80 mm. Comparing FIG. 15 with FIG. 17, it can be confirmed that a peak frequency decreases as a mass m₂ increases.

FIG. 18 illustrates sound absorption characteristics of the sound absorption apparatus 10 according to the third example under a condition that the length L1 is 120 mm. Comparing FIG. 17 with FIG. 18, it can be confirmed that the peak frequency decreases as the length L1 increases. Further, in FIG. 18, since the peak frequency of a sound absorption apparatus according to a comparative example is approximately in the middle of the two peak frequencies of the sound absorption apparatus 10 according to the third example, it can be said that the eigenvalue matching is achieved.

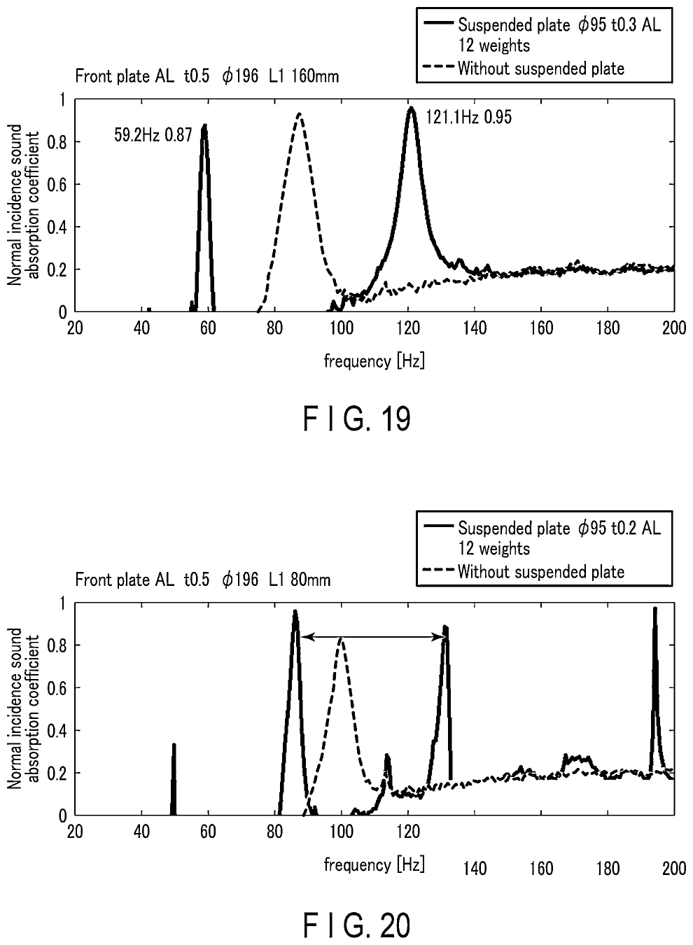

FIG. 19 illustrates sound absorption characteristics of the sound absorption apparatus 10 according to the third example under a condition that the length L1 is 160 mm. Comparing FIGS. 17, 18, and 19, it can be confirmed that the peak frequency decreases as the length L1 increases. As illustrated in FIG. 19, under the condition that the length L1 is 160 mm, the two peak frequencies are near 60 Hz and 120 Hz.

In a fourth example, a suspended plate 15 is an aluminum plate having a diameter of 95 mm and a thickness of 0.2 mm. Twelve weights 16 are attached to an outer edge portion of a suspended plate 15 in twelve equal intervals.

FIG. 20 illustrates sound absorption characteristics of the sound absorption apparatus 10 according to the fourth example under a condition that the length L1 is 80 mm. Comparing FIG. 17 with FIG. 20, it can be confirmed that an interval between the peak frequencies decreases when the suspended plate 15 is thinned (that is, the rigidity of the suspended plate 15 is reduced).

From FIGS. 13 to 20, it can be confirmed that the sound absorption apparatus 10 having the configuration illustrated in FIG. 1 has a high sound absorption coefficient at two frequencies, and further, the validity of the above-described parameter adjustment method can be confirmed. As illustrated in FIGS. 13 and 19, the parameter adjustment can provide the sound absorption apparatus 10 that absorbs the noise having the fundamental frequency and the noise having the frequency twice the fundamental frequency, such as 60 Hz and 120 Hz.

Next, a parameter estimation method will be described. Each parameter estimation method described below is for estimating a parameter value capable of realizing a desired sound absorption characteristic, and facilitates parameter adjustment.

The configuration of the sound absorption apparatus 10 illustrated in FIG. 1 corresponds to the two-degree-of-freedom system model illustrated in FIG. 2, and a motion equation can be described as follows.

$${m}_{1} \ddot{{x}_{1}} + {k}_{1} {x}_{1} + {c}_{1} \dot{{x}_{1}} + {k}_{2} ( {x}_{1} - {x}_{2} ) + {c}_{2} ( \dot{{x}_{1}} - \dot{{x}_{2}} ) = f \\ {m}_{2} \ddot{{x}_{2}} + {k}_{2} ( {x}_{2} - {x}_{1} ) + {c}_{2} ( \dot{{x}_{2}} - \dot{{x}_{1}} ) = 0$$

Here, f is a force applied to the front plate 11 by a sound wave.

When the eigenfrequency ωₙ₁ including (m₁, k₁) is ωₙ₁²=k₁/m₁, the eigenfrequency ωₙ₂ including (m₂, k₂) is ωₙ₂²=k₂/m₂, and the mass ratio is α=m₂/m₁, the eigenfrequencies ωᵣ₁ and ωᵣ₂ can be obtained by the following Expressions (1) and (2).

$${ω}_{r 1}^{2} = ( B - \sqrt{{B}^{2} - 4 C} ) / 2 \qquad ( 1 )$$

$${ω}_{r 2}^{2} = ( B + \sqrt{{B}^{2} - 4 C} ) / 2 \qquad ( 2 )$$

$$B = ( 1 + α ) {ω}_{n 2}^{2} + {ω}_{n 1}^{2} \\ C = {ω}_{n 1}^{2} {ω}_{n 2}^{2}$$

A first parameter estimation method will be described. In the first parameter estimation method, sound absorption coefficient measurement is performed in a state where the suspended plate 15 is not provided, a frequency having a sound absorption coefficient peak value is specified, and an eigenfrequency ωm₁ is obtained from the specified frequency. Furthermore, with the suspended plate 15 attached, the sound absorption coefficient is measured to specify two frequencies having the sound absorption coefficient peak values, and the eigenfrequencies ωᵣ₁ and ωᵣ₂ are obtained from the specified frequencies. The first parameter estimation method estimates parameters of the model illustrated in FIG. 2 using these eigenfrequencies ωₙ₁, ωᵣ₁, and ωᵣ₂. However, the first parameter estimation method does not estimate the parameter value itself, but obtains a parameter group obtained by normalizing m₁ to 1.

When the following Expressions (3) and (4) are set, the following Expression (5) is derived from the above Expressions (1) and (2).

$$- {ω}_{r 1}^{2} + {ω}_{r 2}^{2} = {ω}_{sa} \qquad ( 3 )$$

$${λ}_{2} = {ω}_{n 2}^{2} \qquad ( 4 )$$

$${( 1 + α )}^{2} {λ}_{2}^{2} + 2 ( α - 1 ) {ω}_{n 1}^{2} {λ}_{2} + {ω}_{n 1}^{4} - {ω}_{sa}^{2} = 0 \qquad ( 5 )$$

Therefore, the wavelength λ₂ corresponding to the eigenfrequency ωₙ₂ is expressed by the following Expression (6).

$${λ}_{2} = \frac{- ( α - 1 ) {ω}_{n 1}^{2} + \sqrt{{( ( α - 1 ) {ω}_{n 1}^{2} )}^{2} - {( 1 + α )}^{2} ( {ω}_{n 1}^{4} - {ω}_{sa}^{2} )}}{{( 1 + α )}^{2}} \qquad ( 6 )$$

As shown in the above Expression (6), the wavelength λ₂ depends on the mass ratio α. Therefore, a graph with the horizontal axis α and the vertical axis ωᵣ₂-ωᵣ₁ is constructed, and α in which ωᵣ₂-ωᵣ₁ matches the measurement value is obtained. When α is determined, ωₙ₂ is determined from the above Expressions (4) and (6), and ωₙ₁ is obtained from the measurement result, so that ωᵣ₁ and ωᵣ₂ can be obtained from the above Expressions (1) and (2). Therefore, the above-described graph can be drawn. When α is estimated by this procedure, ωₙ₂ can also be estimated by Expressions (4) and (6). Furthermore, when m₁ is normalized to 1, ωₙ₁, ωₙ₂, α, and m₁ can be determined, and thus m₂, k₁, and k₂ are obtained.

However, since m₁ is normalized to 1, each parameter is a value obtained by dividing the true value by m₁. The attenuation coefficients c₁ and c₂ are set so as to match the measurement result.

Since each parameter is obtained by the above procedure, the transmission characteristics dx1 and dx2 illustrated in the following Expressions (8) and (9) can be obtained by the following Expression (7).

$$M \ddot{X} + C \dot{X} + KX = F \\ \begin{matrix}M = [ \begin{matrix}{m}_{1} & 0 \\ 0 & {m}_{2}\end{matrix} ] & K = [ \begin{matrix}{k}_{1} + {k}_{2} & - {k}_{2} \\ - {k}_{2} & {k}_{2}\end{matrix} ] & C = [ \begin{matrix}{c}_{1} + {c}_{2} & - {c}_{2} \\ - {c}_{2} & {c}_{2}\end{matrix}\end{matrix} ] \\ \begin{matrix}F = [ \begin{matrix}f \\ 0\end{matrix} ] & X = [ \begin{matrix}{x}_{1} \\ {x}_{2}\end{matrix} ]\end{matrix} \qquad ( 7 )$$

$$Transmission characteristics from f to \dot{{x}_{1}} \qquad ( 8 )$$

$$Transmission characteristics from f to \dot{{x}_{2}} \qquad ( 9 )$$

Since the sound absorption effect correlates with the kinetic energy, the tendency of the sound absorption coefficient can be estimated by the transmission characteristics dx1 and dx2 shown in the above (8) and (9).

The kinetic energy consumed by the front plate 11 and the suspended plate 15 is as follows, and thus the transmission characteristic of the vibration speed correlates with the sound absorption coefficient.

$$( {m}_{1} \dot{{x}_{1}^{2}} + {m}_{2} \dot{{x}_{2}^{2}} ) / 2$$

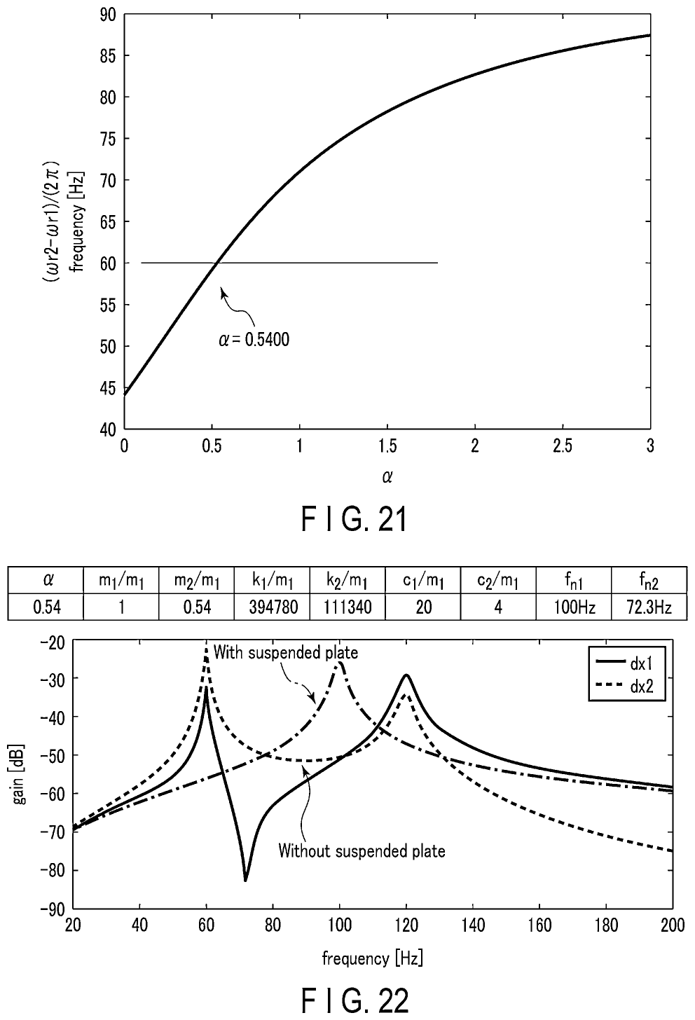

In the first example (L1=80 mm), as illustrated in FIG. 13, ωₙ₁/2π=100 Hz, ωᵣ₁/2π=61 Hz, and ωᵣ₂/2π=119.8 Hz. With repetition of the following operation while changing the mass ratio α, a graph with a horizontal axis α and a vertical axis ωᵣ₂-ωᵣ₁ illustrated in FIG. 21 is created. The operation includes setting the value of the mass ratio α, substituting the eigenfrequencies ωₙ₁, ωᵣ₁, and ωᵣ₂ and the mass ratio into the above Expression (6) to obtain the eigenfrequency ωₙ₂, and obtaining the eigenfrequencies ωᵣ₁ and ωᵣ₂ from the eigenfrequencies ωₙ₁ and ωₙ₂ and the above Expressions (1) and (2).

Since ωᵣ₁/2π=61 Hz and ωᵣ₂/2π=119.8 Hz are obtained as the measurement values, the mass ratio α when (ωᵣ₁-ωᵣ₂)/2π becomes about 60 Hz is determined from FIG. 21. In this example, α=0.54. The eigenfrequency ωₙ₂ is calculated from ωₙ₁/2π=100 Hz, ωᵣ₁/2π=61 Hz, ωᵣ₂/2π=119.8 Hz, α=0.54, and Expressions (4) and (6).

Through the above-described processing, the eigenfrequencies ωₙ₁ and ωₙ₂, the mass ratio α, and the mass m₁ are determined. From these values, the mass m₂ and the spring constants k₁ and k₂ are calculated. The attenuation coefficients c₁ and c₂ are set to be similar to the measurement result.

FIG. 22 illustrates a parameter estimation result and a vibration transmission characteristic estimation result for the first example under a condition that the length L1 is 80 mm. In FIG. 22, a solid line indicates the estimation result of the transmission characteristic dx1, a broken line indicates the estimation result of the transmission characteristic dx2, and a one-dot chain line indicates the estimation result of the transmission characteristic when the suspended plate 15 is not provided. From FIG. 22, it can be confirmed that the transmission characteristic dx1 is similar to the tendency of the sound absorption coefficient.

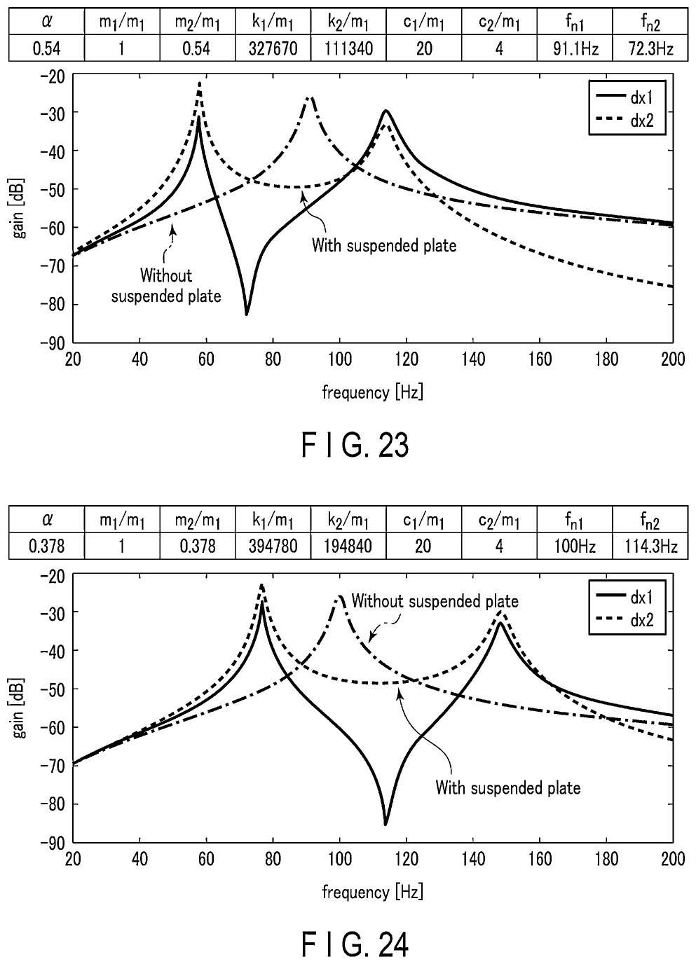

FIG. 23 illustrates a parameter estimation result and a vibration transmission characteristic estimation result for the first example under a condition that the length L1 is 120 mm. Assuming that the rigidity of the air spring decreases as the length L1 increases from 80 mm to 120 m, the spring constant k₁ is set to a smaller value. The value of the spring constant k₁ is determined such that the eigenfrequency in the absence of the suspended plate 15 is similar to the measurement result. From FIG. 23, it can be confirmed that the transmission characteristic dx1 is similar to the tendency of the sound absorption coefficient. Therefore, it is found to be appropriate that the peak frequency decreases as the length L1 increases.

FIG. 24 illustrates a parameter estimation result and a vibration transmission characteristic estimation result according to a second example under a condition that a length L1 is 80 mm. Assuming that the spring constant k₂ increases as the diameter of a suspended plate 15 decreases from 115 mm to 95 mm, the spring constant k₂ is set to a larger value. It can be confirmed from FIG. 24 that an interval between the peak frequencies increases. Therefore, it is found that it is appropriate to increase the interval between the peak frequencies when the radius of the suspended plate 15 is reduced.

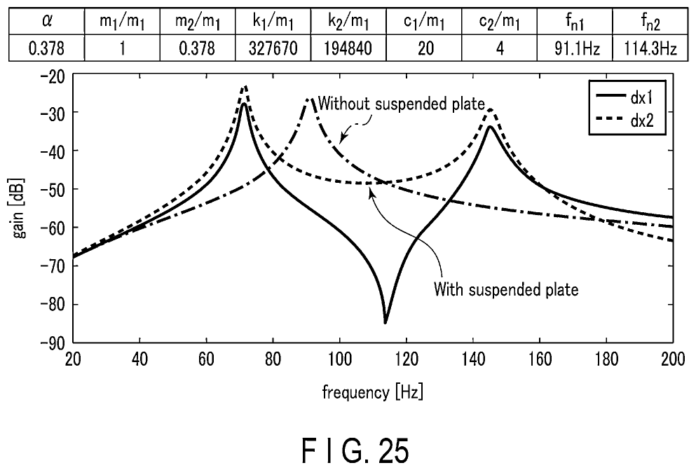

FIG. 25 illustrates the parameter estimation result and the vibration transmission characteristic estimation result according to the second example under a condition that the length L1 is 120 mm. Assuming that the rigidity of the air spring decreases as the length L1 increases from 80 mm to 120 m, the spring constant k₁ is set to a smaller value. FIG. 25 shows that it is reasonable that the peak frequency decreases as the length L1 increases.

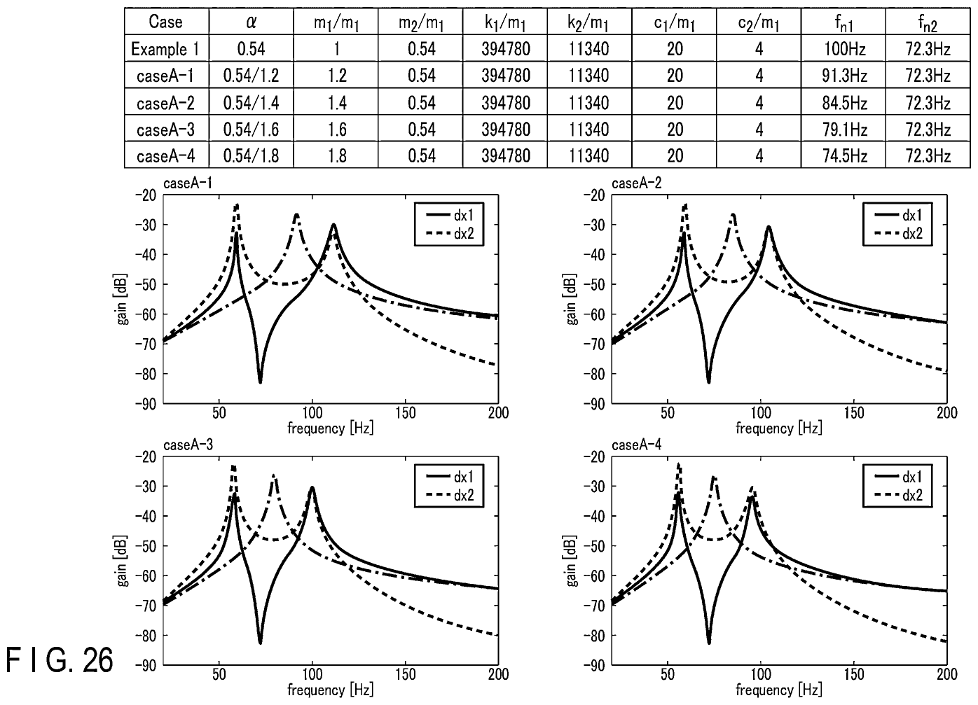

A change tendency of the vibration transmission characteristic due to parameter change will be described with reference to FIGS. 26, 27, and 28.

FIG. 26 illustrates a change in the vibration transmission characteristic when the mass m₁ is increased. From FIG. 26, it can be confirmed that when the mass m₁ is increased, the eigenfrequency ωₙ₁ decreases, and further, the frequency at which the vibration transmission characteristics dx1 and dx2 peak tends to decrease.

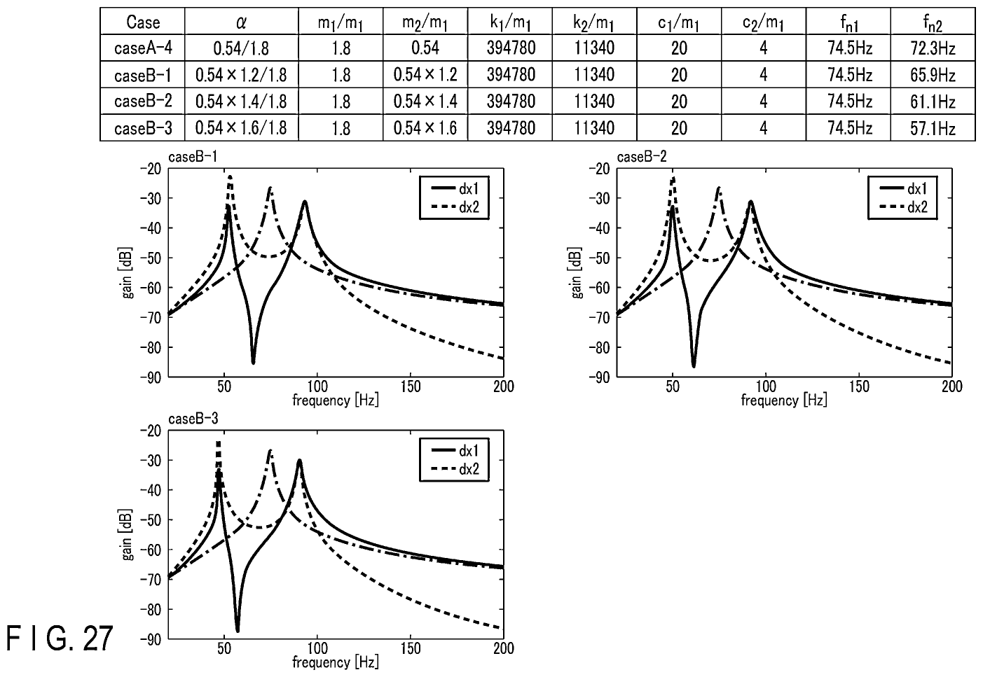

FIG. 27 illustrates a change in the vibration transmission characteristic when the mass m₂ is increased. From FIG. 27, it can be confirmed that when the mass m₂ is increased, the eigenfrequency ωₙ₂ decreases, and further, the frequency at which the vibration transmission characteristics dx1 and dx2 peak tends to decrease.

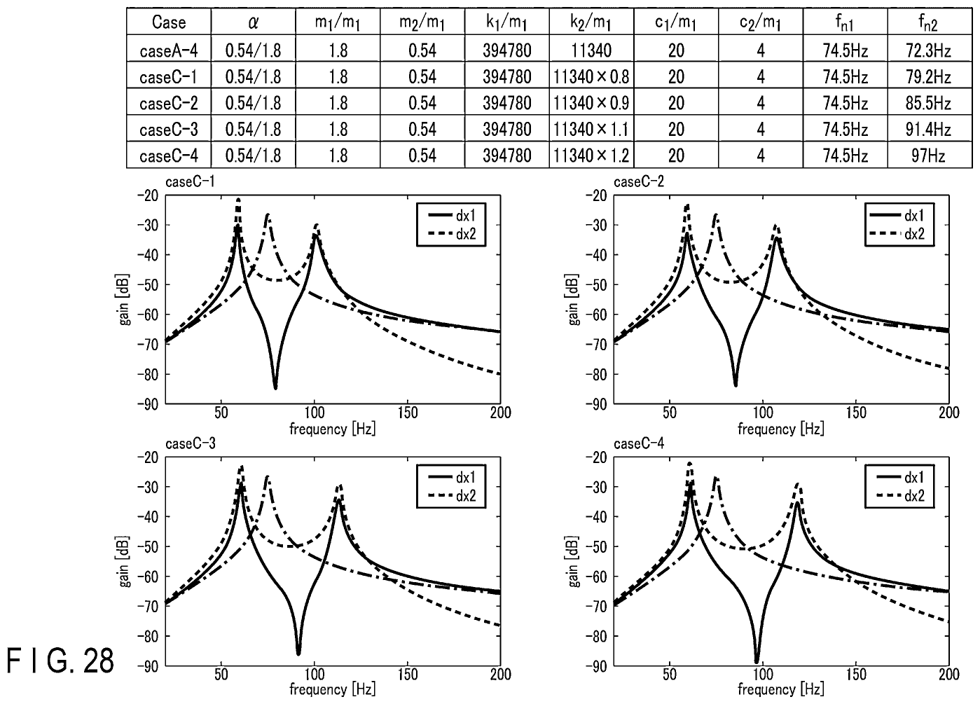

FIG. 28 illustrates a change in the vibration transmission characteristic when the spring constant k₂ is increased. From FIG. 28, it can be confirmed that when the spring constant k₂ is increased, the eigenfrequency ωₙ₂ increases, and the interval between frequencies at which the vibration transmission characteristics dx1 and dx2 peak tends to increase.

As described above, since the measurement result can be reproduced by the first parameter estimation method, a change in tendency due to parameter adjustment can be grasped in advance by simulation, and a parameter tuning test can be performed. That is, parameter tuning can be performed without trial and error.

However, in the first parameter estimation method, since the mass m₁ is normalized to 1, only the tendency can be grasped. That is, it is not possible to determine how many grams the mass m₂ should be increased, and it is possible to grasp whether the mass m₂ should be increased or decreased in order to obtain desired sound absorption characteristics.

A second parameter estimation method will be described. The second parameter estimation method estimates a parameter as a physical property value using the first parameter estimation method. As an outline, in the second parameter estimation method, the sound absorption coefficient is measured under the condition that the weight of the weight 16 is different, and the mass m₂ is determined from the measurement result. According to the second parameter estimation method, it is possible to grasp, to some extent, the determination of how many grams the mass m₂ should be increased in order to obtain desired sound absorption characteristics.

### Procedure 0)

The sound absorption coefficient measurement is performed under two conditions where the weights of the weights 16 provided on the suspended plate 15 are different.
Case1: m₂ (reference)
Case2: m₂ (reference)+m₂ₛ

Here, m₂ₛ represents a mass difference between two conditions. The mass difference m₂ₛ is known because it is the mass of the added weight 16.

### Procedure 1)

For each of Case1 and Case2, the mass ratio α and the eigenfrequency ωₙ₂ are derived by the first parameter estimation method. The mass ratio α of Case1 is represented by α₁, and the mass ratio α of Case2 is represented by α₂.

### Procedure 2)

Since the mass m₁ is common to Case1 and Case2, the mass m₂ is obtained from the following Expression.

$${m}_{2} = \frac{{m}_{2 s} {α}_{1}}{{α}_{2} - {α}_{1}}$$

### Procedure 3)

For each of Case1 and Case2, m₁, k₁, and k₂ are obtained from ωₙ₁, ωₙ₂, α, and m₂. Note that ωₙ₁ is obtained from the measurement value.

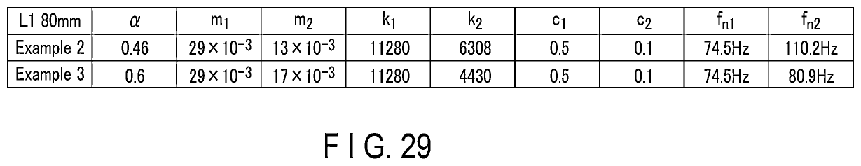

FIG. 29 illustrates parameter estimation results in the second example and a third example under the condition that the length L1 is 80 mm. The second example corresponds to Case1, the third example corresponds to Case2, and the mass difference m₂ₛ is 4 grams. As illustrated in FIG. 29, in the third example in which the number of weights 16 is increased, the value of α is increased. In addition, since the distribution changes from four equal distribution to twelve equal distribution, the spring constant k₂ decreases in the third example.

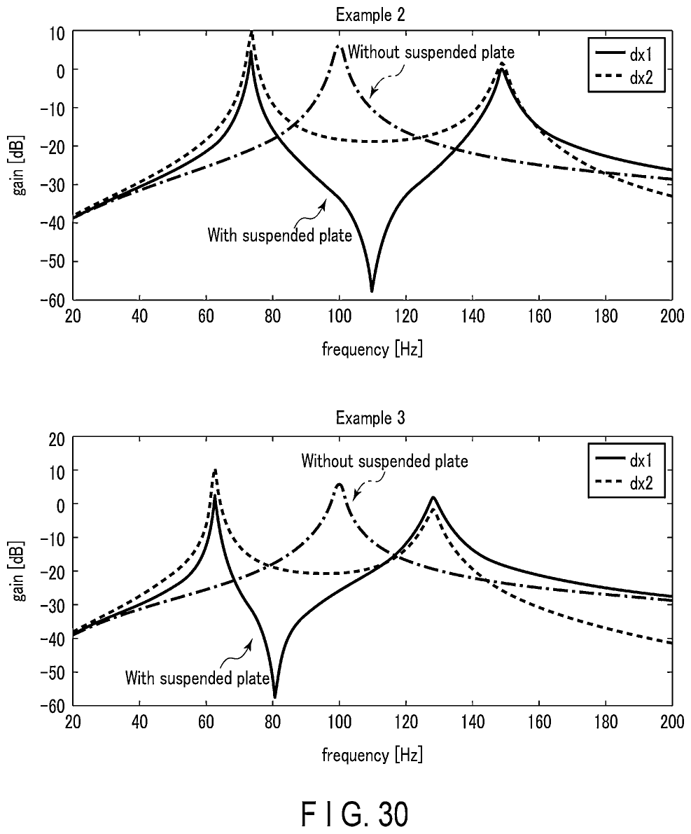

FIG. 30 illustrates the vibration transmission characteristic based on the parameter estimation result illustrated in FIG. 29. From FIG. 30, it can be confirmed that the vibration transmission characteristic dx1 has a similar tendency to the sound absorption characteristic indicated in the measurement result.

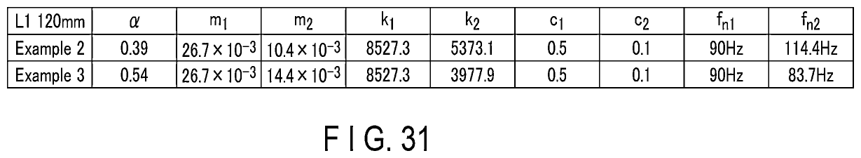

FIG. 31 illustrates parameter estimation results in the second example and the third example under the condition that the length L1 is 120 mm. The second example corresponds to Case1, the third example corresponds to Case2, and the mass difference m₂ₛ is 4 grams. As described with reference to FIG. 29, in the third example, the value of the mass ratio α increases and the spring constant k₂ decreases.

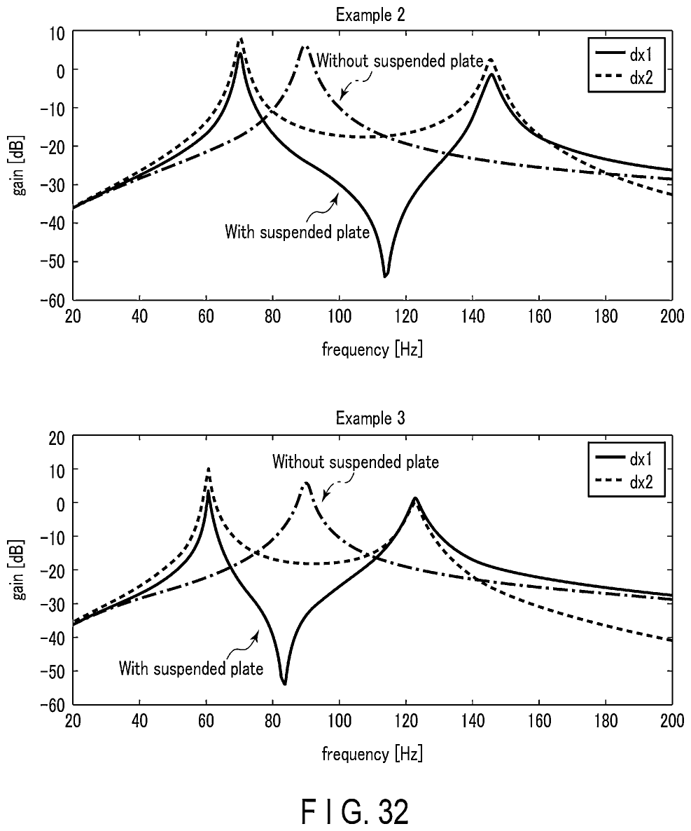

FIG. 32 illustrates the vibration transmission characteristic based on the parameter estimation result illustrated in FIG. 31. From FIG. 32, it can be confirmed that the vibration transmission characteristic dx1 has a similar tendency to the sound absorption characteristic indicated in the measurement result.

Comparing FIGS. 29 and 31, it can be confirmed that the mass ratio α decreases as the length L1 increases. For example, in the second example, α=0.46 when the length L1 is 80 mm, and α=0.39 when the length L1 is 120 mm. In the third example, α=0.6 when the length L1 is 80 mm, and α=0.54 when the length L1 is 120 mm. Since such a difference is considered to be due to a measurement error, it can be said that it is desirable to average a in order to further improve the parameter estimation accuracy.

A third parameter estimation method will be described. The third parameter estimation method uses the second parameter estimation method. Specifically, in the third parameter estimation method, the second parameter estimation method is applied to two sound absorption apparatuses having different lengths L1 of a hollow member 12 to obtain two mass ratios, and an average thereof is obtained as the mass ratio α.

### Procedure 0)

Sound absorption coefficient measurement is performed under two conditions where the number of weights 16 is different.
Case1: m₂ (reference), L1 (reference)
Case2: m₂ (reference)+m₂ₛ, L1 (reference)

The sound absorption coefficient is measured under two conditions in which the length L1 is changed and the number of weights 16 is different.
Case1′: m₂ (reference), L1 (change)
Case2′: m₂ (reference)+m₂ₛ, L1 (changed)

### Procedure 1)

For each of Case1, Case2, Case1′, and Case2′, the mass ratio α and the eigenfrequency ωₙ₂ are derived by the first parameter estimation method.

### Procedure 2)

α in Case1 and α in Case1′ are averaged to obtain α₁.
α in Case2 and α in Case2′ are averaged to obtain α₂.

### Procedure 3)

ωₙ₂ is obtained from a correspondence relationship between α and ωₙ₂ obtained in Procedure 1 in each case.

### Procedure 4)

Since the mass m₁ is common to Case1 and Case2, the mass m₂ (reference) is obtained from the following expression.

$${m}_{2} = \frac{{m}_{2 s} {α}_{1}}{{α}_{2} - {α}_{1}}$$

### Procedure 5)

m₁, k₁, and k₂ are obtained from ωₙ₁, ωₙ₂, α, and m₂. Specifically, for each of Case1 and Case1′, m₁, k₁, and k₂ are obtained from ωₙ₁, ωₙ₂, α₁, and m₂, and for each of Case2 and Case2′, m₁, k₁, and k₂ are obtained from ωn, ωₙ₂, ω2, and m₂. Note that ωₙ₁ is obtained from the measurement value.

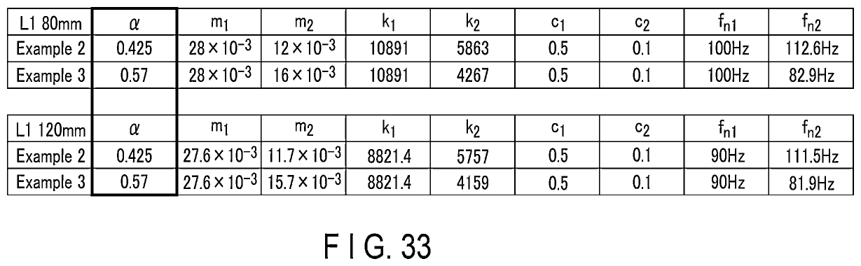

FIG. 33 illustrates parameter estimation results in the second and third examples under the condition that the length L1 is 80 mm and the second and third examples under the condition that the length L1 is 120 mm. As illustrated in FIG. 29, α=0.46 in the second example under the condition that the length L1 is set to 80 mm, and as illustrated in FIG. 31, α=0.39 in the second example under the condition that the length L1 is set to 120 mm. In the parameter estimation result illustrated in FIG. 33, the mass ratio α is an average of 0.425. As illustrated in FIG. 29, α=0.6 in the third example under the condition that the length L1 is 80 mm, and as illustrated in FIG. 31, α=0.54 in the third example under the condition that the length L1 is 120 mm. In the parameter estimation result illustrated in FIG. 33, the mass ratio α is an average of 0.57. As described above, in the third parameter estimation method, the mass ratio α is the same regardless of the length L1.

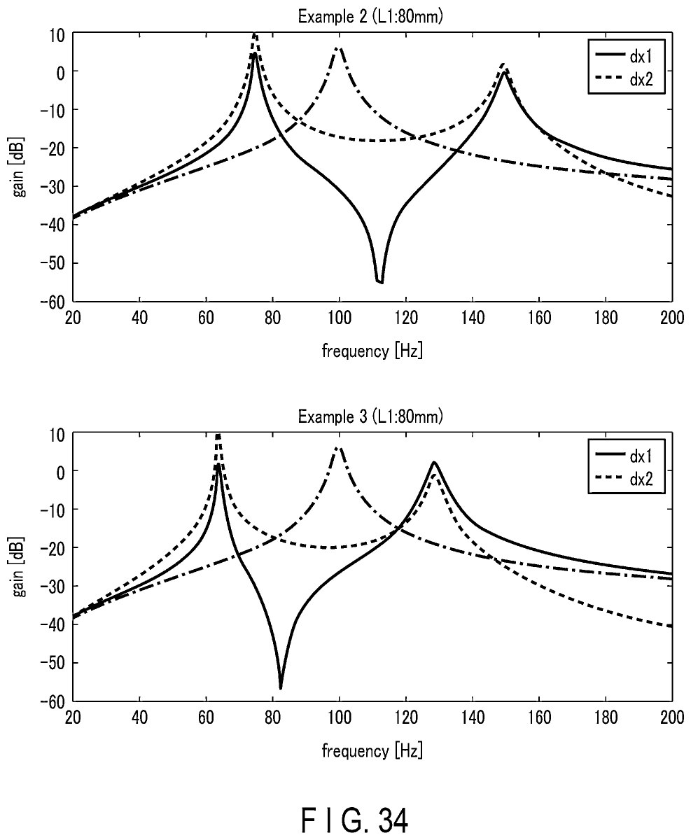

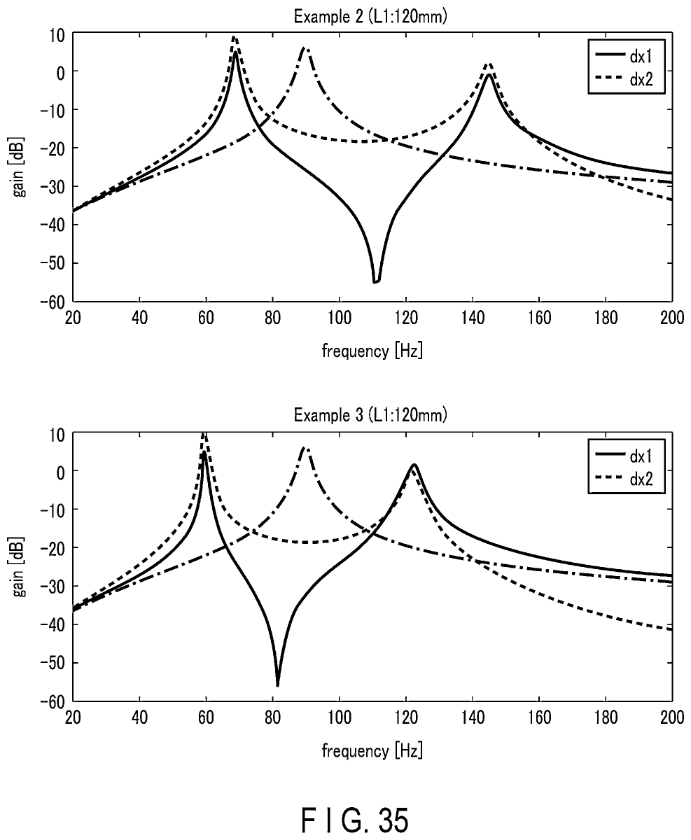

FIG. 34 illustrates the vibration transmission characteristics based on the parameter estimation results in the second example and the third example under the condition that the length L1 is 80 mm illustrated in FIG. 33, and FIG. 35 illustrates the vibration transmission characteristics based on the parameter estimation results in the second example and the third example under the condition that the length L1 is 120 mm illustrated in FIG. 33. As illustrated in FIGS. 34 and 35, since the mass ratio α is averaged, there is a slight difference between the vibration transmission characteristic dx1 and the sound absorption characteristic indicated in the measurement result. However, it is possible to sufficiently grasp the tendency of the sound absorption characteristics from the vibration transmission characteristics dx1 illustrated in FIGS. 34 and 35.

The first parameter estimation method, the second parameter estimation method, and the third parameter estimation method have been described above. The first parameter estimation method can be estimated from one piece of measurement data. Since the mass m₁ is normalized, a specific mass change cannot be obtained, but an indication of an increase/decrease direction can be made. The second parameter estimation method can be estimated from two pieces of measurement data in which the mass m₂ is changed. A specific mass change and the like can be obtained. However, the estimation result includes the influence of the measurement error. The third parameter estimation method can be estimated from four pieces of measurement data in which the mass m₂ and the length L1 are changed. A specific mass change and the like can be obtained. Since the averaging is used, the influence of the measurement error can be suppressed.

Design targets of the sound absorption apparatus 10 are as follows.
Noise at a fundamental frequency and a frequency twice the fundamental frequency is reduced.
A high sound absorption coefficient (for example, 0.6) is achieved for the above two frequencies.
Compact size

Therefore, parameter tuning is performed such that the length L1 is made as small as possible, the relationship between the two frequencies is maintained, and the two frequencies have high vibration transmission characteristics.

Based on this, an example of parameter tuning using the third parameter estimation method will be described.

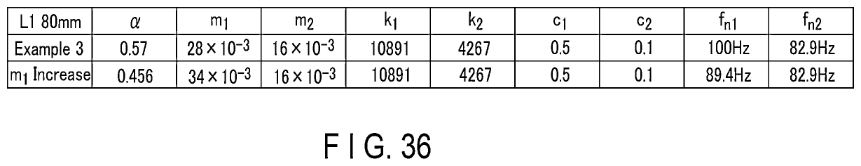

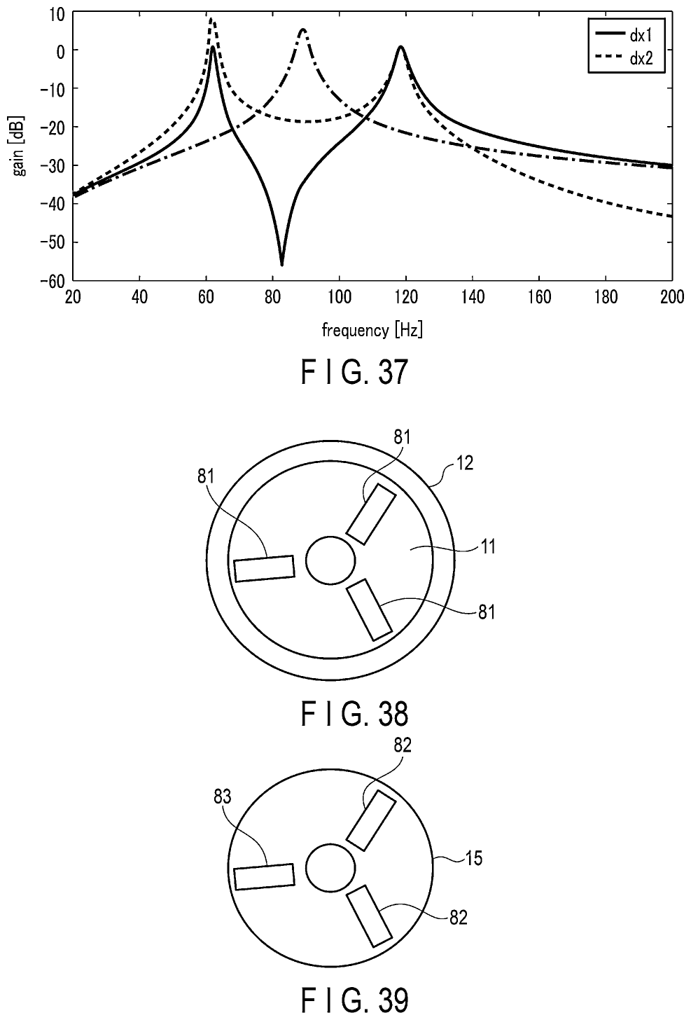

FIG. 36 illustrates a parameter estimation result when the mass m₁ is increased by 6 g with respect to the third example in which the length L1 is set to 80 mm, and FIG. 37 illustrates a vibration transmission characteristic based on the parameter estimation result illustrated in FIG. 36. As illustrated in FIG. 37, the vibration transmission characteristic peaks at intended frequencies of 60 Hz and 120 Hz. Since the length L1 is 80 mm, a compact size is obtained.

As described above, according to the parameter estimation method described above, parameter tuning can be performed without trial and error.

The front plate 11 and the suspended plate 15 vibrate by receiving sound waves. Power can be generated using the vibration of the front plate 11 and the suspended plate 15. For example, piezoelectric films 81 as piezoelectric elements may be attached to the front plate 11 as illustrated in FIG. 38, or piezoelectric films 82 as piezoelectric elements may be attached to the suspended plate 15 as illustrated in FIG. 39. For example, the piezoelectric films 81 and/or the piezoelectric films 82 are connected to an electric circuit including a full-wave rectifier through a conductive wire, and AC power generated by the piezoelectric films 81 and/or the piezoelectric films 82 are converted into DC power by the electric circuit and supplied to a load such as a sensor.

The sound absorption apparatus 10 can be used as each of a plurality of units configuring the acoustic metamaterial.

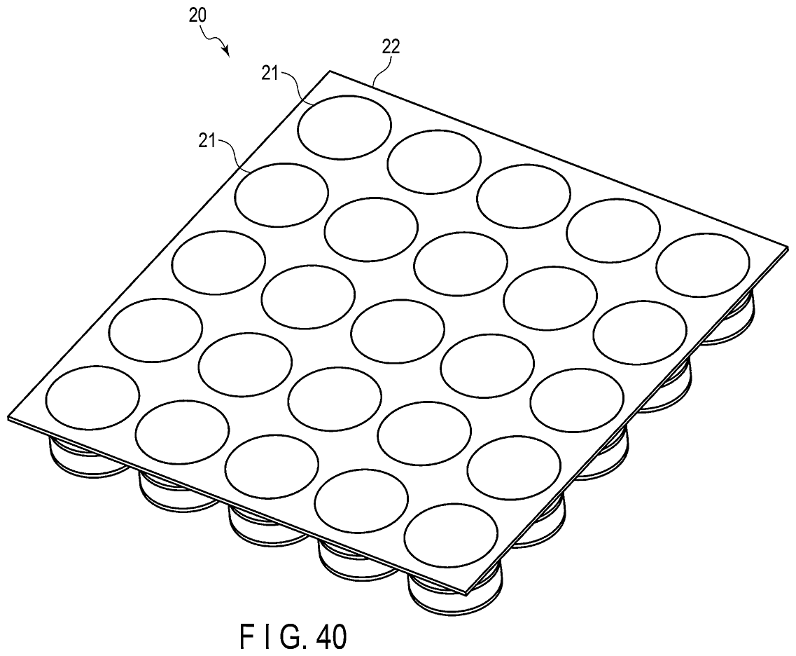

FIG. 40 schematically illustrates an acoustic metamaterial 20 according to the embodiment. As illustrated in FIG. 40, the acoustic metamaterial 20 includes a plurality of units 21 and a plate member 22. The units 21 are periodically (in this example, in a matrix) arranged and fixed to the plate member 22. As each unit 21, a sound absorption apparatus 10 illustrated in FIG. 1 is used.

As described above, the sound absorption apparatus 10 according to the present embodiment includes the front plate 11, the hollow member 12, the back plate 13, the connection member 14, and the suspended plate 15. The front plate 11 is connected to the hollow member 12 and configured to vibrate. The back plate 13 faces the front plate 11 and is connected to the hollow member 12. The front plate 11, the back plate 13, and the hollow member 12 form the internal space 30. The suspended plate 15 is suspended from the front plate 11 by the connection member 14 in the internal space 30.

In the above configuration, the front plate 11 receives the sound wave and vibrates, and the suspended plate 15 vibrates with the vibration of the front plate 11. As a result, sound of two frequencies in the low frequency band can be absorbed. In addition, since the number of components is small, the configuration is simple. Further, a Helmholtz sound hole plate is unnecessary. Therefore, it can be manufactured at low cost.

In one example, a bolt can be used as the connection member 14. In this case, the weight of the connection member 14 can be easily adjusted using the nut and the washer. Therefore, it is easy to adjust the frequency at which the sound absorption apparatus 10 can absorb sound.

A plurality of weights 16 may be dispersedly arranged or an annular weight may be arranged in an outer edge portion of the suspended plate 15. By attaching the weight to the suspended plate 15, it is easy to adjust the frequency at which the sound absorption apparatus 10 can absorb sound. In one example, bolts can be used as weight 16. In this case, the weight of the weight 16 can be easily adjusted using the nut or the like. Therefore, it is easier to adjust the frequency at which the sound absorption apparatus 10 can absorb sound.

The sound absorption apparatus 10 may further include a fixture that includes the bands 56 corresponding to a string member, and connects the front plate 11 and the back plate 13 to the hollow member 12 using the tension of the band 56. In this configuration, the sound absorption apparatus 10 can be easily disassembled, and parameter adjustment for adjusting the frequency at which the sound absorption apparatus 10 can absorb sound is easy.

The front plate 11 and/or the suspended plate 15 may be provided with a piezoelectric film. In this configuration, power generation can be performed together with sound absorption.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The parameter estimation methods according to the embodiments described above may be described as in the following supplementary notes but are not limited thereto.

### Supplementary Note 1

A method for estimating a parameter in a sound absorption apparatus including: a hollow member; a first plate connected to the hollow member and configured to vibrate; a second plate provided opposite to the first plate and connected to the hollow member; a third plate disposed between the first plate and the second plate and configured to vibrate; a connection member connecting the third plate to the first plate; and a weight provided on the third plate, wherein the first plate, the second plate, and the hollow member form an internal space, and the third plate is suspended from the first plate by the connection member in the internal space, the method comprising:
determining a first eigenfrequency and a second eigenfrequency corresponding to two frequencies having two sound absorption coefficient peak values by measuring sound absorption characteristics of the sound absorption apparatus;
determining a third eigenfrequency corresponding to a frequency having a sound absorption coefficient peak value by measuring a sound absorption characteristic of the sound absorption apparatus in a state where the third plate is not provided;
determining a mass ratio based on the first eigenfrequency, the second eigenfrequency, and the third eigenfrequency, the mass ratio being a ratio of a second mass to a first mass, the second mass representing a mass of the weight and an equivalent mass of the third plate, the first mass representing a mass of the connection member and an equivalent mass of the first plate;
determining a fourth eigenfrequency that is an eigenfrequency of a degree-of-freedom system including the third plate and the weight, based on the first eigenfrequency, the second eigenfrequency, the third eigenfrequency, and the mass ratio; and
determining the second mass, a first spring constant representing equivalent rigidity of the first plate and an air spring in the internal space, and a second spring constant representing equivalent rigidity of the third plate based on the mass ratio, the third eigenfrequency, and the fourth eigenfrequency by normalizing the first mass to 1.

### Supplementary Note 2

A method for estimating a parameter in a sound absorption apparatus including: a hollow member; a first plate connected to the hollow member and configured to vibrate; a second plate provided opposite to the first plate and connected to the hollow member; a third plate disposed between the first plate and the second plate and configured to vibrate; a connection member connecting the third plate to the first plate; and a weight provided on the third plate, wherein the first plate, the second plate, and the hollow member form an internal space, and the third plate is suspended from the first plate by the connection member in the internal space, the method comprising:
performing, for each of a first condition in which a second mass is a first value and a second condition in which the second mass is a second value greater than the first value, processing including:
   determining a first eigenfrequency and a second eigenfrequency corresponding to two frequencies having two sound absorption coefficient peak values by measuring sound absorption characteristics of the sound absorption apparatus;
   determining a third eigenfrequency corresponding to a frequency having a sound absorption coefficient peak value by measuring a sound absorption characteristic of the sound absorption apparatus in a state where the third plate is not provided;
   determining a mass ratio based on the first eigenfrequency, the second eigenfrequency, and the third eigenfrequency, the mass ratio being a ratio of the second mass to a first mass, the second mass representing a mass of the weight and an equivalent mass of the third plate, the first mass representing a mass of the connection member and an equivalent mass of the first plate; and
   determining a fourth eigenfrequency that is an eigenfrequency of a degree-of-freedom system including the third plate and the weight based on the first eigenfrequency, the second eigenfrequency, the third eigenfrequency, and the mass ratio;
determining the first value based on a difference between the first mass and the second mass, the mass ratio corresponding to the first condition, and the mass ratio corresponding to the second condition; and determining, for each of the first condition and the second condition, the first mass, a first spring constant representing equivalent rigidity of the first plate and an air spring in the internal space, and a second spring constant representing equivalent rigidity of the third plate based on the third eigenfrequency, the fourth eigenfrequency, the mass ratio, and the first value.

### Supplementary Note 3

A method for estimating a parameter in a sound absorption apparatus including: a hollow member; a first plate connected to the hollow member and configured to vibrate; a second plate provided opposite to the first plate and connected to the hollow member; a third plate disposed between the first plate and the second plate and configured to vibrate; a connection member connecting the third plate to the first plate; and a weight provided on the third plate, wherein the first plate, the second plate, and the hollow member form an internal space, and the third plate is suspended from the first plate by the connection member in the internal space, the method comprising:
performing, for each of a first condition in which a second mass is a first value and a length of the hollow member is a second value, a second condition in which the second mass is a third value greater than the first value and the length of the hollow member is the second value, a third condition in which the second mass is the first value and the length of the hollow member is a fourth value greater than the second value, and a fourth condition in which the second mass is the third value and the length of the hollow member is the fourth value, processing including:
   determining a first eigenfrequency and a second eigenfrequency corresponding to two frequencies having two sound absorption coefficient peak values by measuring sound absorption characteristics of the sound absorption apparatus;
   determining a third eigenfrequency corresponding to a frequency having a sound absorption coefficient peak value by measuring a sound absorption characteristic of the sound absorption apparatus in a state where the third plate is not provided;
   determining a mass ratio based on the first eigenfrequency, the second eigenfrequency, and the third eigenfrequency, the mass ratio being a ratio of the second mass to a first mass, the second mass representing a mass of the weight and an equivalent mass of the third plate, the second mass representing a mass of the connection member and an equivalent mass of the first plate; and
   determining a fourth eigenfrequency that is an eigenfrequency of a degree-of-freedom system including the third plate and the weight based on the first eigenfrequency, the second eigenfrequency, the third eigenfrequency, and the mass ratio;
calculating an average of the mass ratio corresponding to the first condition and the mass ratio corresponding to the third condition as a first average mass ratio;
calculating an average of the mass ratio corresponding to the second condition and the mass ratio corresponding to the fourth condition as a second average mass ratio;
determining the first value based on a difference between the first mass and the second mass, the first average mass ratio, and the second average mass ratio;
determining, for each of the first condition and the third condition, the first mass, a first spring constant representing equivalent rigidity of the first plate and an air spring in the internal space, and a second spring constant representing equivalent rigidity of the third plate based on the third eigenfrequency, the fourth eigenfrequency, the first average mass ratio, and the first value; and
determining, for each of the second condition and the fourth condition, the first mass, the first spring constant, and the second spring constant based on the third eigenfrequency, the fourth eigenfrequency, the second average mass ratio, and the first value.

What is claimed is:

1. A sound absorption apparatus, comprising:
a hollow member;
a first plate connected to the hollow member and configured to vibrate;
a second plate provided opposite to the first plate and connected to the hollow member;
a third plate disposed between the first plate and the second plate and configured to vibrate; and
a connection member connecting the third plate to the first plate, wherein
the first plate, the second plate, and the hollow member form an internal space, and
the third plate is suspended from the first plate by the connection member in the internal space.

2. The sound absorption apparatus according to claim 1, wherein the connection member includes a bolt.

3. The sound absorption apparatus according to claim 2, wherein
the connection member further includes a plurality of nuts into which the bolt is inserted,
the third plate has an opening, through which the bolt is inserted, in a central portion thereof, and is fixed by the plurality of nuts, and
the first plate has an opening, through which the bolt is inserted, in a central portion thereof, and is fixed by the plurality of nuts.

4. The sound absorption apparatus according to claim 3, wherein the connection member further includes a plurality of washers into which the bolt is inserted.

5. The sound absorption apparatus according to claim 4, wherein the plurality of washers includes a plurality of washers positioned continuously between the first plate and a nut that fixes the first plate, or between the third plate and a nut that fixes the third plate.

6. The sound absorption apparatus according to claim 4, wherein the plurality of washers includes at least two types of washers of different materials.

7. The sound absorption apparatus according to claim 4, wherein
the third plate has an opening provided in a peripheral portion, and
the bolt is inserted through the opening.

8. The sound absorption apparatus according to claim 1, further comprising a plurality of weights dispersedly arranged in a peripheral portion of the third plate.

9. The sound absorption apparatus according to claim 8, wherein the plurality of weights includes screws.

10. The sound absorption apparatus according to claim 1, further comprising an annular weight provided in a peripheral portion of the third plate.

11. The sound absorption apparatus according to claim 1, further comprising a fixture including a string member and configured to connect the first plate and the second plate to the hollow member using tension of the string member.

12. The sound absorption apparatus according to claim 1, further comprising a piezoelectric element provided on the first plate.

13. The sound absorption apparatus according to claim 1, further comprising a piezoelectric element provided on the third plate.
